(19) United States
(12) Patent Application Publication
(10) Pub. No.: US 2012/0050272 A1
(43) Pub. Date: Mar. 1, 2012

(54) IMAGE PROCESSING DEVICE, DISPLAY DEVICE, REPRODUCING DEVICE, RECORDING DEVICE, METHOD FOR CONTROLLING IMAGE PROCESSING DEVICE, INFORMATION RECORDING MEDIUM, CONTROL PROGRAM FOR IMAGE PROCESSING DEVICE, AND COMPUTER-READABLE STORAGE MEDIUM

(75) Inventors: Noboru Iwata, Osaka-Shi (JP); Hideharu Tajima, Osaka-Shi (JP)

(73) Assignee: Sharp Kabushiki Kaisha, Osaka-Shi (JP)

(21) Appl. No.: 13/212,792

(22) Filed: Aug. 18, 2011

(30) Foreign Application Priority Data
Aug. 30, 2010 (JP) 192828/2010

(51) Int. Cl. G06T 15/00

(52) U.S. Cl. 345/419

(57) ABSTRACT

An image processing device includes: an image region specifying section for specifying a first image region and/or a second image region; and a pixel value changing section for changing a pixel value of the first image region and/or the second image region specified by the image region specifying section to a pixel value indicative of a predetermined pattern. The first image region (i) includes an object that exists in the image for the left eye and does not exist in the image for the right eye and (ii) is defined based on a left side of the image for the left eye. The second image region (a) includes an object that exists in the image for the right eye and does not exist in the image for the left eye and (b) is defined based on a right side of the image for the right eye.

This Nonprovisional application claims priority under 35 U.S.C. §119(a) on Patent Application No. 2010-192828 filed in Japan on Aug. 30, 2010, the entire contents of which are hereby incorporated by reference.

### TECHNICAL FIELD

The present invention relates to an image processing device etc. each of which carries out image processing with respect to a three-dimensional (3D) image.

### BACKGROUND ART

In recent years, intensive studies have been carried out for a viewing method etc. of a 3D image, which is other than a two-dimensional (2D) image. For example, there have been a 3D display device etc. in which a 3D image is displayed by utilizing a parallax between an image for a right eye and an image for a left eye.

Such a 3D display device has the following problem. In rightmost and leftmost regions of a display, a region (non-corresponding region) that exists only in one of the images for the right eye and the left eye occurs. This causes a visual rivalry, thereby reducing a stereoscopic effect. Patent Literature 1 discloses a technique for solving this problem.

Patent Literature 1 discloses a binocular stereoscopic viewing device in which (i) a correlation between a pixel of the image for the right eye and a pixel of the image for the left eye is checked and (ii) regions other than pixels corresponding to each other in the respective images for the right eye and the left eye are removed from the images so that the images having no such regions are presented to an output. This suppresses or prevents a visual rivalry, thereby improving a stereoscopic effect.

Another example of the viewing method of the 3D image is a 3D image conversion method, in which a 2D image is displayed in a pseudo manner as a 3D image. For example, there has been known a method of achieving a 3D image having a parallax by (i) causing a delay in a display of an original 2D image according to movement of the original 2D image and (ii) using a video signal of the original 2D image as an image for a left eye and a delay signal as an image for a right eye. Patent Literature 2 discloses a technique for achieving sufficient depth by this method.

Patent Literature 2 discloses a method for displaying a 3D image, in which method a display screen has a horizontally-long aspect ratio as compared to an aspect ratio of a 3D image signal. This method makes it possible to cause the image for the left eye and the image for the right eye to horizontally shift relative to each other, and to prevent lack of images caused by the shifting. Accordingly, it is possible to achieve sufficient depth in the 3D image conversion method.

### CITATION LIST

### Patent Literatures

Patent Literature 1
Japanese Patent Application Publication, Tokukaihei, No. 5-316541 A (Publication Date: Nov. 26, 1993)
Japanese Patent Application Publication, Tokukaihei, No. 8-205203 A (Publication Date: Aug. 9, 1996)

### SUMMARY OF INVENTION

### Technical Problem

However, the technique of the Patent Literature 1 has the following problem. According to the technique of Patent Literature 1, a correlation between pixels of the respective images for the left eye and the right eye is checked for each pixel. Therefore, when pixels having different values are removed from the respective images, the following problem occurs. The following description discusses this problem with reference to FIG. 10. FIG. 10 illustrates an example of how image processing according to a conventional technique is carried out. (a) of FIG. 10 is a view illustrating an original image not processed by a binocular stereoscopic viewing device of Patent Literature 1. (b) of FIG. 10 is a view illustrating an image having been processed by the binocular stereoscopic viewing device. (c) of FIG. 10 is a view illustrating an image obtained when the image of (b) of FIG. 10 is displayed three-dimensionally.

Assume that the images for the right eye and the left eye are made from original images illustrated in (a) of FIG. 10. In this case, regions having different pixel values are removed from the respective original images, and the images (processed images) for the right eye and the left eye as illustrated in (b) of FIG. 10 are presented to an output.

In a case where a user who views an image displayed on an output (e.g., display device) focuses on a near view, an object A of the image for the left eye and an object A′ of the image for the right eye of (b) of FIG. 10 are in focus (the objects A and A′ represent an identical airplane, see (c) of FIG. 10). However, in this case, a region P, which resulted from removal of the foregoing region from the image for the left eye, is displayed as an unnatural region having no image.

On the other hand, in a case where the user focuses on a distant view, an object B of the image for the left eye and an object B′ of the image for the right eye are in focus (the objects B and B′ represent an identical mountain, see (b) of FIG. 10). However, in this case, a region Q, which resulted from removal of the foregoing region from the image for the right eye, is displayed as an unnatural region having no image.

That is, the technique of Patent Literature 1 has a problem in which an unnatural image that cannot occur in the real world is displayed. That is, in the vicinities of the right and left edges of the processed images, an object on the background is cut off in the middle or an object is displayed in a region having no background. This problem is more noticeable in a case of a near view object, because the near view object is shown to the viewer with emphasis as compared to a distant view object.

Further, the technique of Patent Literature 2 is applicable only when horizontal shifting for depth adjustment is given to the images for the right eye and the left eye. In other words, the technique of Patent Literature 2 is not applicable to a 3D image that is not subjected to such horizontal shifting for the depth adjustment.

Furthermore, according to Patent Literature 2, an image to be subjected to the depth adjustment is taken with a monocular camera and is for a two-dimensional display. On the other hand, the image for the right eye and the image for the left eye for a three-dimensional display are taken with a binocular camera, and therefore each of the images has a region existing only therein. Therefore, even with use of the technique of Patent Literature 2 for the images for the three-dimensional display, it is not possible to solve a problem in which an unnatural image appears when the images are subjected to the image processing as in Patent Literature 1.

That is, the techniques of Patent Literatures 1 and 2 are not capable of solving a problem in which, because of an object (part of object) that appears in only one of the images for the right eye and the left eye for a three-dimensional display utilizing a parallax, a stereoscopic effect is reduced (i.e., it becomes difficult to perceive depth) and the three-dimensional display looks blur.

The present invention has been made in view of the problem, and an object of the present invention is to provide an image processing device, a display device, a reproducing device, a recording device, a method for controlling an image processing device, an information recording medium, a control program for an image processing device, and a computer-readable storage medium, each of which is capable of suppressing a reduction in a stereoscopic effect of a three-dimensional display utilizing a parallax.

### Solution to Problem

In order to attain the above object, an image processing device in accordance with the present invention is an image processing device for carrying out image processing with respect to a first parallax image and a second parallax image which are for a three-dimensional display, the first parallax image and the second parallax image each having (i) a first edge and a second edge opposed to each other in a first axis direction and (ii) a third edge and a fourth edge opposed to each other in a second axis direction orthogonal to the first axis direction, said image processing device, including: image region specifying means for specifying a first image region and/or a second image region; and pixel value changing means for changing a pixel value of the first image region and/or the second image region specified by the image region specifying means to a pixel value indicative of a predetermined pattern, the first image region (i) including an object that exists in the first parallax image and does not exist in the second parallax image and (ii) being defined based on the first edge of the first parallax image and extending continuously from the third edge to the fourth edge, and the second image region (a) including an object that exists in the second parallax image and does not exist in the first parallax image and (b) being defined based on the second edge of the second parallax image and extending continuously from the third edge to the fourth edge.

In order to attain the above object, a method for controlling an image processing device in accordance with the present invention is a method for controlling an image processing device, the image processing device carrying out image processing with respect to a first parallax image and a second parallax image which are for a three-dimensional display, the first parallax image and the second parallax image each having (i) a first edge and a second edge opposed to each other in a first axis direction and (ii) a third edge and a fourth edge opposed to each other in a second axis direction orthogonal to the first axis direction, said method, including the steps of: specifying a first image region and/or a second image region; and changing a pixel value of the first image region and/or the second image region specified in the step of specifying to a pixel value indicative of a predetermined pattern, the first image region (i) including an object that exists in the first parallax image and does not exist in the second parallax image and (ii) being defined based on the first edge of the first parallax image and extending continuously from the third edge to the fourth edge, and the second image region (a) including an object that exists in the second parallax image and does not exist in the first parallax image and (b) being defined based on the second edge of the second parallax image and extending continuously from the third edge to the fourth edge.

According to the above configuration, the image region specifying means specifies the first image region or the second image region which includes an object that exists in one of parallax images and does not exist in the other. In a case where the object that exists in one of the parallax images and does not exist in the other exists at both the first edge (on first-edge side) of the first parallax image and the second edge (on second-edge side) of the second parallax image, the image region specifying means specifies both the first image region and the second image region. Then, the pixel value changing means changes, to a pixel value indicative of a predetermined pattern, a pixel value of the first image region and/or the second image region thus specified.

Note here that the predetermined pattern is a figured pattern or a colored pattern etc. for preventing the object in the first image region or the second image region from being displayed. The predetermined pattern is for example a black-colored pattern, a pattern of a color similar to black, a pattern of fine stripes or a dot pattern. Further, note that the pixel value is a numerical value indicative of luminance and color of a pixel.

Further, note that the term “orthogonal to” does not mean that the first axis and the second axis intersect each other at accurately 90°. That is, even in a case where the first axis and the second axis intersect each other at an angle other than 90°, the first axis and the second axis are regarded as being “orthogonal to” each other provided that the first axis and the second axis intersect each other in the first and second parallax images so that each of the first through fourth edges can be independently defined.

Accordingly, it is possible not only to remove from the first and second parallax images an object that is not the same between the first and second parallax images (see (b) of FIG. 10), but also to change a pixel value of a region having such an object to a pixel value indicative of a predetermined pattern. This makes it possible to prevent an unnatural region having no image (see (c) of FIG. 10) from appearing when the images are displayed three-dimensionally, and thus to suppress a reduction in a stereoscopic effect.

Particularly in a case where there are near view objects on a first-edge side of the first parallax image and on a second-edge side of the second parallax image, the above suppression of a reduction in a stereoscopic effect is advantageous. The reason therefor is as follows.

In a case where an image is displayed three-dimensionally, usually, a near view object in the image is displayed as if it is popping out at a viewer. In other words, the near view object is shown with emphasis to the viewer, thereby attracting the viewer's attention. Therefore, it is particularly difficult for the viewer to recognize depth of the near view object as compared to a distant view, and as a result, the image looks blur. That is, in a case where there is an object that is not the same between the first and second parallax images, influence of such an object becomes more noticeable (i.e., stereoscopic effect is more reduced) toward a near-view side.

According to the image processing device of the present invention, (i) the first image region and the second image region are specified on the first-edge side of the first parallax image and on the second-edge side of the second parallax image, respectively, on which sides there is near view objects and (ii) a pixel value of each of the first and second image regions is changed to a pixel value indicative of a predetermined pattern. That is, in a near view, not only (a) an object that exists in one of parallax images and does not exist in the other but also (b) an entire region that includes the object and extends continuously from the third edge to the fourth edge are prevented from being displayed.

This, makes it possible to prevent an unnatural region (region P in (c) of FIG. 10) having no image, which unnatural region cannot occur in the real world, from appearing in the near view that is prone to a reduction in a stereoscopic effect during three-dimensional display. That is, this makes it possible to improve quality of an image displayed three-dimensionally.

According to Patent Literature 2, it is necessary to prepare a display screen having an aspect ratio horizontally longer than an aspect ratio of an image, in order to prevent a reduction in a stereoscopic effect due to horizontal shifting. In this regard, the processing carried out by the image processing device of the present invention does not include image processing by the horizontal shifting. Accordingly, it is possible to prevent a reduction in a stereoscopic effect without changing the aspect ratio.

Further, according to the processing carried out by the image processing device of the present invention, it is also possible to (i) independently specify each of the first and second image regions and (ii) change a pixel value of each of the first and second image regions to a pixel value indicative of a predetermined pattern. However, according to Patent Literature 2, it is not possible to remove edge, portions having different widths from respective images for a right eye and a left eye (i.e., it is not possible to set the first image region and the second image region so that they have respective different areas), because a lack of display in the edge portions of the images during three-dimensionally is prevented by horizontally shifting a pair of the images for the right eye and the left eye.

Note that, for example in a case where the first parallax image is an image for a left eye and the second parallax image is an image for a right eye, a first-edge side of the first parallax image (e.g., a left part of the image for the left eye) and a second-edge side of the second parallax image (e.g., a right part of the image for the right eye) represent a near view in images when the images are displayed three-dimensionally. On the other hand, a second-edge side of the first parallax image (e.g., a right part of the image for the left eye) and a first-edge side of the second parallax image (e.g., a left part of the image for the right eye) represent a distant view in images when the images are displayed three-dimensionally.

### Advantageous Effects of Invention

As has been described, an image processing device in accordance with the present invention includes: image region specifying means for specifying a first image region and/or a second image region; and pixel value changing means for changing a pixel value of the first image region and/or the second image region specified by the image region specifying means to a pixel value indicative of a predetermined pattern, the first image region (i) including an object that exists in the first parallax image and does not exist in the second parallax image and (ii) being defined based on the first edge of the first parallax image and extending continuously from the third edge to the fourth edge, and the second image region (a) including an object that exists in the second parallax image and does not exist in the first parallax image and (b) being defined based on the second edge of the second parallax image and extending continuously from the third edge to the fourth edge.

Further, as has been described, a method for controlling an image processing device in accordance with the present invention includes the steps of: specifying a first image region and/or a second image region; and changing a pixel value of the first image region and/or the second image region specified in the step of specifying to a pixel value indicative of a predetermined pattern, the first image region (i) including an object that exists in the first parallax image and does not exist in the second parallax image and (ii) being defined based on the first edge of the first parallax image and extending continuously from the third edge to the fourth edge, and the second image region (a) including an object that exists in the second parallax image and does not exist in the first parallax image and (b) being defined based on the second edge of the second parallax image and extending continuously from the third edge to the fourth edge.

Therefore, the image processing device and the method for controlling the image processing device in accordance with the present invention make it possible to prevent an unnatural region having no image from appearing when images are displayed three-dimensional display, and thus possible to suppress a reduction in a stereoscopic effect.

### BRIEF DESCRIPTION OF DRAWINGS

FIG. 1

FIG. 1 is a block diagram illustrating an example of how a main part of an image processing device of an embodiment of the present invention is configured.

FIG. 2

FIG. 2 is a view for explaining a near view image and a distant view image. (a) of FIG. 2 illustrates how images are displayed as a near view image. (b) of FIG. 2 illustrates how images are displayed as a distant view image.

FIG. 3

FIG. 3 is a flowchart illustrating an example of a process carried out in an image processing device of an embodiment of the present invention.

FIG. 4

FIG. 4 is a flowchart illustrating an example of a process carried out in a parallax maximum width detection section of an image processing device of an embodiment of the present invention.

FIG. 5

FIG. 5 is a view illustrating an example of how image processing is carried out by an image processing device of an embodiment of the present invention. (a) of FIG. 5 is a view illustrating original images not processed by the image processing device. (b) of FIG. 5 is a view illustrating images obtained from the original images through the image processing by the image processing device. (c) of FIG. 5 is a view illustrating how the images of (b) of FIG. 5 look when they are displayed three-dimensionally.

FIG. 6

FIG. 6 is a view illustrating an example of schematic configurations of a recording/reproducing device and a display device each having a main configuration of an image processing device of an embodiment of the present invention.

FIG. 7

FIG. 7 is a view illustrating an example of a schematic configuration of an optical disc to which an image having been processed by, an image processing device of an embodiment of the present invention is recorded.

FIG. 8

FIG. 8 is a block diagram illustrating an example of how a main part of an image processing device of a modification of an embodiment of the present invention is configured.

FIG. 9

FIG. 9 is a flowchart illustrating an example of a process carried out in an image processing device of modification of an embodiment of the present invention.

FIG. 10

FIG. 10 is a view illustrating how image processing is carried out by a conventional technique. (a) of FIG. 10 is a view illustrating original images not processed by a binocular stereoscopic viewing device of Patent Literature 1. (b) of FIG. 10 is a view illustrating images obtained from the original images through the processing by the binocular stereoscopic viewing device. (c) of FIG. 10 is a view illustrating how the images of (b) of FIG. 10 look when they are displayed three-dimensionally.

### DESCRIPTION OF EMBODIMENTS

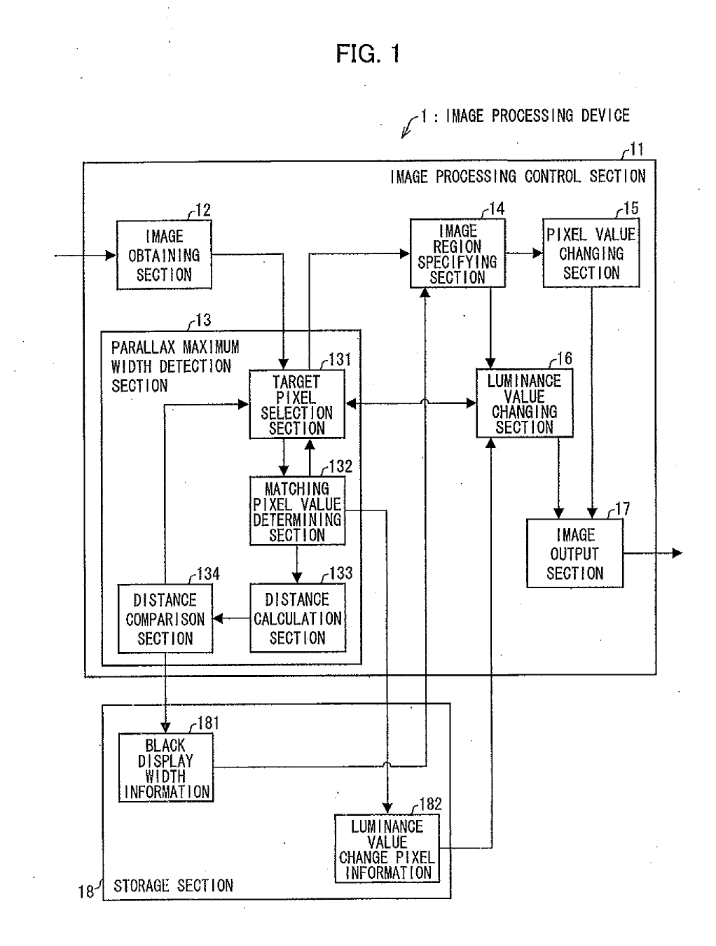

The following description discusses an embodiment of the present invention with reference to FIGS. 1 through 10. For convenience of description, members having functions identical to those illustrated in the drawings are assigned identical referential numerals, and their descriptions are omitted.

### [Configuration of Image Processing Device 1]

The following description discusses, with reference to FIG. 1, how a main part of an image processing device 1 is configured. FIG. 1 is a block diagram illustrating an example of how the main part of the image processing device 1 is configured.

The image processing device 1 carries out image processing with respect to an image (first parallax image) for a left eye and an image (second parallax image) for a right eye which are for a three-dimensional display utilizing a parallax, and includes mainly an image processing control section 11 and a storage section 18. The present embodiment is based on the assumption that images for the three-dimensional display are the image for the left eye and the image for the right eye, Note, however, that the images for the three-dimensional display are not limited to these, and therefore can be images of any kind provided that they are two images for the three-dimensional display utilizing a parallax.

The image processing control section 11 includes mainly an image obtaining section 12, a parallax maximum width detection section 13, an image region specifying section 14 (image region specifying means, step of specifying image region), a pixel value changing section 15 (pixel value changing means, step of changing pixel value), a luminance value changing section 16 (luminance value changing means), and an image output section 17. The image processing control section 11 controls constituents of the image processing device 1 by for example executing a control program. The image processing control section 11 reads out a program stored in the storage section 18, loads the program to a primary storage section (not illustrated) constituted by for example a RAM (Random Access Memory), and executes the program, thereby carrying out various processing such as image processing with respect to an obtained image for a left eye and an image for a right eye.

The image obtaining section 12 obtains (i) content stored in an external device such as a display device 40 (described later) or a recording/reproducing device 10 (recording device, reproducing device) (or content that the external device has obtained from outside) and (ii) a group of images that are stored in the storage section 18 and constitute the content. The image obtaining section 12 transmits each of the images in the group to the parallax maximum width detection section 13 for example in the order in which the images are received. Note that each of the images is constituted by an image for a left eye and an image for a right eye for achieving a three-dimensional display utilizing a parallax.

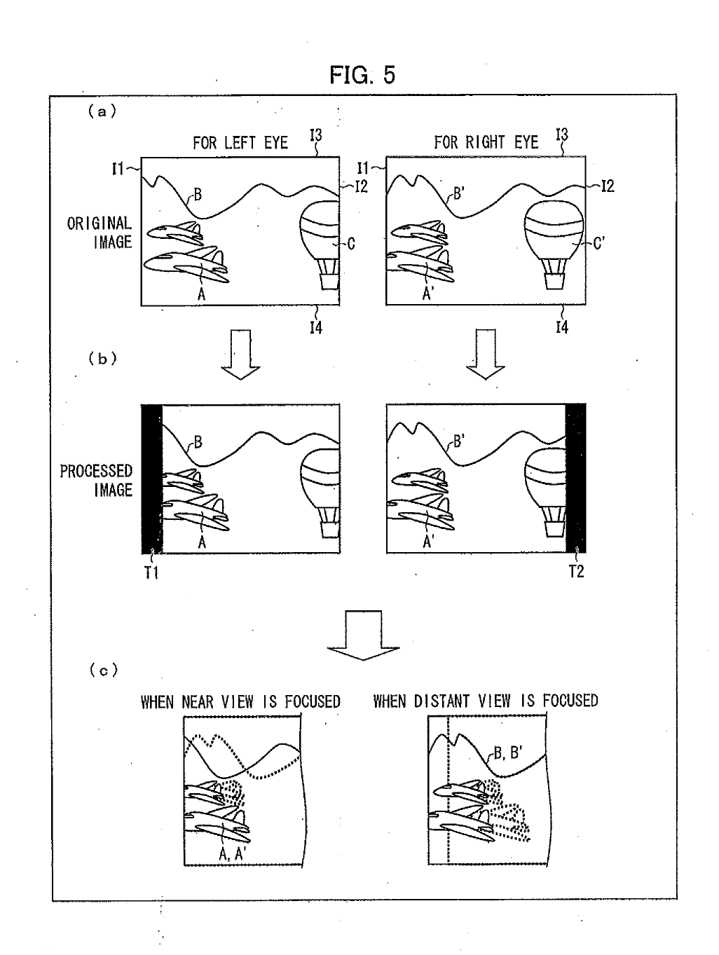

Upon receiving an image from the image obtaining section 12, the parallax maximum width detection section 13 detects a parallax maximum width. The parallax maximum width is a width of a first image region T1 or a second image region T2 (refer to (b) of FIG. 5 for T1 and T2), which is specified by the image region specifying section 14. To this end, the parallax maximum width detection section 13 includes a target pixel selection section 131, a matching pixel value determining section (matching pixel value determining means) 132, a distance calculation section 133, and a distance comparison section (maximum distance specifying means) 134. Note that the parallax maximum width detection section 13 detects the parallax maximum width of each of the images for the left eye and the right eye.

Further, in accordance with an instruction by the luminance value changing section 16, the parallax maximum width detection section 13 detects, from a group of pixels constituting the image for the left eye and/or the image for the right eye, a pixel whose luminance value is to be changed. The parallax maximum width detection section 13 then stores a detected pixel in the storage section 18. The pixel thus stored serves as luminance value change pixel information 182.

Note here that, as illustrated in (b) of FIG. 5, the first image region T1 is a region including an object that exists in the image for the left eye and does not exist in the image for the right eye. The first image region T1 is defined based on a left side I1 (first edge) of the image for the left eye and extends continuously from an upper side I3 (third edge) to a lower side I4 (fourth edge). Similarly, the second image region T2 is, as illustrated in (b) of FIG. 5, a region including an object that exists in the image for the right eye and does not exist in the image for the left eye. The second image region T2 is defined based on a right side I2 (second edge) of the image for the right eye and extends continuously from an upper side I3 to a lower side I4.

When the images are displayed three-dimensionally, an object in the image for the right eye is provided so as to be shifted leftward (when seen from a viewer) relative to an object in the image for the left eye. This results in a state where the viewer's eyes are focused on somewhere in front of the display screen, and thus creates a near view object perceived as popping out at the viewer from a display screen. Since an object on the near-view side is displayed in an enhanced manner, a reduction in a stereoscopic effect tends to be noticeable to the viewer and the images tend to be perceived by the viewer as being blur if the object on the near-view side exists, on a left side and a right side of the display screen, only in either one of the parallax images (specifically, if the object exists only on a left side I1 side of the image for the left eye or on a right side I2 side of the image for the right eye).

On the other hand, a distant view object perceived as receding in a background of the display is created by providing the object in the image for the right eye so that the object is shifted rightward (when seen from the viewer) relative to the object in the image for the left eye, because this results in a state where the viewer's eyes are focused on somewhere behind the display screen. Since the distant view object is not shown to the viewer in the enhanced manner, the images do not tend to be perceived as being blur even if the distant view object exists only in either one of the parallax images (specifically, even if the object exists only on a right side I2 side of the image for the left eye or on a left side I1 side of the image for the right eye). In view of this, on the right side I2 side of the image for the left eye and the left side I1 side of the image for the right eye, it is not necessarily have to change a pixel value of a predetermined region including the object to a pixel value indicative of a predetermined pattern even if the object exists only in either one of the parallax images.

That is, the parallax maximum width detection section 13 (described later) can have any configuration provided that it detects a width of a region on the left side I1 side of the image for the left eye and a width of a region on the right side I2 side of the image for the right eye, which regions are on a near-view side. Further, the image region specifying section 14 can have any configuration provided that it specifies a region having a detected width. Note here that the parallax maximum width detection section 13 and the image region specifying section 14 can detect, by carrying out a process same as in the near-view side, a width of a region on the right side I2 side of the image for the left eye and a width of a region on the left side I1 side of the image for the right eye, which regions are on a distant-view side, and specify such regions.

Further, according to the present embodiment, (i) the first edge and the second edge opposed to each other in a long axis direction (first axis direction) of each of the images for the right eye and the left eye are referred to as the left side I1 and the right side I2, respectively and (ii) the third edge and the fourth edge opposed to each other in a short axis direction (second axis direction) orthogonal to the long axis direction are referred to as the upper side I3 and the lower side I4, respectively (see (a) of FIG. 5). That is, according to the present embodiment, each of the first through fourth edges is not a point but an entire side.

Note that, although the images for the left eye and the right eye each have a quadrangular shape so as to fit a shape of a current display screen, shapes of the images for the left eye and the right eye are not limited to this provided that each of the shapes fits a shape of a display screen. For example, each of the shapes of the images for the left eye and the right eye can be a shape of a racetrack (e.g., first and second edges are curved lines), a shape that fits a curved display surface, or a shape that fits a flexible display.

The target pixel selection section 131 selects a pixel to be checked by the matching pixel value determining section 132, (i) from the image for the left eye when the parallax maximum width in the image for the left eye is to be detected or (ii) from the image for the right eye when the parallax maximum width in the image for the right eye is to be detected. The target pixel selection section 131 selects, upon reception of a first image of the group of images that the image obtaining section 12 obtained, a pixel set as a default (such a pixel is for example a pixel at the upper left corner [i.e., a pixel nearest to an intersection of the right side I1 and the upper side I3] of the image for the left eye or a pixel at the upper right corner [i.e., a pixel nearest to an intersection of the right side I2 and the upper side I3] of the image for the right eye). After selecting a target pixel, the target pixel selection section 131 notifies the matching pixel value determining section 132 of a position of the target pixel.

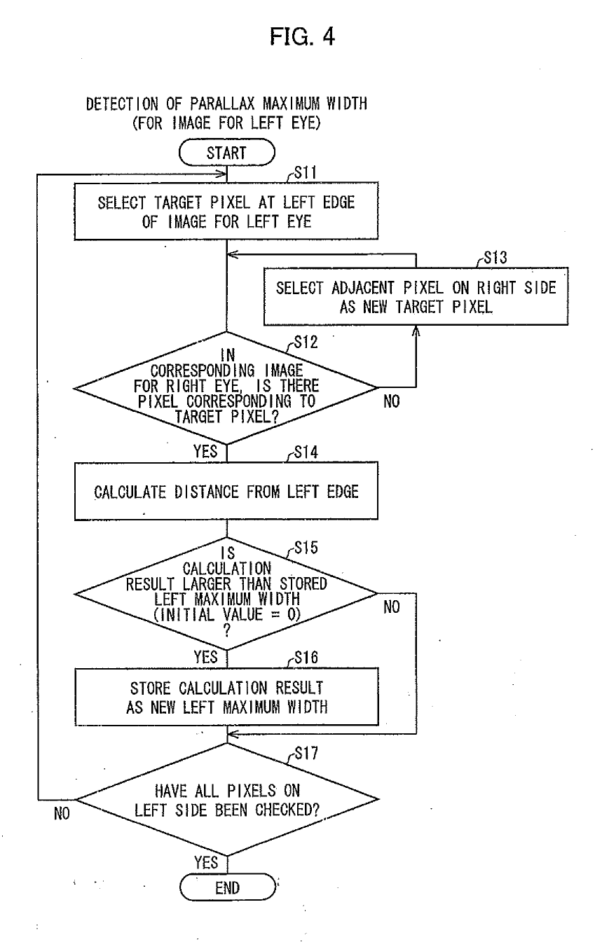

Further, the target pixel selection section 131 again selects a target pixel and then notifies the matching pixel value determining section 132 of a position of the target pixel in a case where the target pixel selection section 131 (i) receives, from the matching pixel value determining section 132, a result indicating that pixel values do not match or (ii) receives, from the distance comparison section 134, a notification indicating that a process has finished. Note that how an order of selection of pixels is determined will be discussed later with reference to FIG. 4.

Further, the target pixel selection section 131 notifies the image region specifying section 14 of completion of a detection process when the parallax maximum width detection section 13 completed the detection process.

Upon receipt of the position of the target pixel selected by the target pixel selection section 131, the matching pixel value determining section 132 determines whether or not a pixel value of the target pixel matches a pixel value of a corresponding pixel in another image corresponding to an image including the target pixel (e.g., in a case where the target pixel is selected from the image for the left eye, such another image is the image for the right eye). The process carried out by the matching pixel value determining section 132 here can be the same as the process carried out by a correspondent point detection section described in Patent Literature 1. Specifically, the process can be carried out by (i) setting a threshold value for determining whether or not pixel values match each other and (ii) determining whether or not the pixel values match each other according to whether or not the pixel values exceed the threshold value.

In other words, the matching pixel value determining section 132 determines, in a case where the parallax maximum width in the image for the left eye is to be detected, whether or not a pixel value of a target pixel of the image for the left eye matches a pixel value of a corresponding pixel of the image for the right eye at a position corresponding to the target pixel. Similarly, in a case where the parallax maximum width in the image for the right eye is to be detected, the matching pixel value determining section 132 determines whether or not a pixel value of a target pixel of the image for the right eye matches a pixel value of a corresponding pixel of the image for the left eye at a position corresponding to the target pixel.

Note here that the “corresponding pixel at a position corresponding to the target pixel” does not mean that the position of the target pixel and the position of the corresponding pixel are represented by exactly the same coordinates (x, y) in the image for the left eye and the image for the right eye, respectively. The “corresponding pixel at a position corresponding to the target pixel” means that the target pixel and the corresponding pixel correspond to each other in the respective images when the images are displayed three-dimensionally. This is because, since there is a parallax in the three-dimensional display, positions of pixels (pixels having identical pixel values) corresponding to each other in the respective images are shifted sideways relative to each other. For example, in a case where a target pixel is selected from the image for the left eye and a position of the target pixel is represented by (x, y), a position of a corresponding pixel corresponding to the target pixel is represented by (x+d, y).

Further, upon receipt of the instruction from the luminance value changing section 16, the target pixel F selection section 131 selects, from pixels in an image region other than the first image region T1 and the second image region T2, a pixel set as a default for this process. For example, a pixel at the upper right corner of the image for the left eye (i.e., a pixel nearest to an intersection of the right side I2 and the upper side I3) and a pixel at the upper left corner of the image for the right eye (i.e., a pixel nearest to an intersection of the left side I1 and the upper side I3) are each set as a default. After selecting a target pixel, the target pixel selection section 131 notifies the matching pixel value determining section 132 of a position of the target pixel.

Upon receiving notification of the position of the target pixel selected by the target, pixel selection section 131, the matching pixel value determining section 132 determines whether or not a pixel value of the target pixel matches a pixel value of a pixel corresponding to the target pixel in an image corresponding to the image including the target pixel.

In a case where these two pixel values do not match each other, the matching pixel value determining section 132 determines that a pixel corresponding to the target pixel of one of parallax images does not exist in the other one of the parallax images. Then, the matching pixel value determining section 132 stores the position of the target pixel in the storage section 18. The position of the target pixel serves as the luminance value change pixel information 182. The matching pixel value determining section 132 then notifies the target pixel selection section 131 of completion of the process to cause the target pixel selection section 131 to select a next pixel.

Upon reception of notification of the completion, the target pixel selection section 131 selects a next target pixel (e.g., a pixel adjacent in the short axis direction to the pixel at the upper right corner, in a case of the image for the left eye). The target pixel selection section 131 selects a next target pixel every time it receives the notification from the matching pixel value determining section 132. After the target pixel selection section 131 selects as target pixels all of the pixels in the image region other than the first image region T1 and the second image region T2 and is notified by the matching pixel value determining, section 132 of completion of the process, the target pixel selection section 131 transmits notification of completion of the process to the luminance value changing section 16. This allows the luminance value changing section 16 to carry out a luminance value changing process.

In a case where the two pixel values match each other, the matching pixel value determining section 132 notifies the distance calculation section 133 of a determination result indicating that the two pixel values match each other. In a case where the two pixel values do not match each other, the matching pixel value determining section 132 notifies the target pixel selection section 131 of a determination result indicating that the two pixel values do not match each other.

According to the present embodiment, the matching pixel value determining section 132 determines whether or not an identical object exists in both the image for the left eye and the image for the right eye according to whether or not pixel values of “pixels” in the respective images for the left eye and the right eye match each other. Note however that, how to carry out the determination is not limited to this. The matching pixel value determining section 132 can be configured to determine whether or not an identical object exists in both the image for the left eye and the image of the right eye according to whether or not pixel values of respective “groups each consisting of a plurality of pixels” match each other, instead of pixel values of the “pixels”.

Upon reception of the determination result indicating that the pixel values match each other from the matching pixel value determining section 132, the distance calculation section 133 calculates (i) a distance between the left side I1 and the target pixel in a case where the image for the left eye is to be subjected to processing or (ii) a distance between the right side I2 and the target pixel in a case where the image for the right eye is to be subjected to processing. The distance calculation section 133 transmits a calculation result to the distance comparison section 134.

The distance comparison section 134 compares the calculation result received from the distance calculation section 133 with a value (initial value: 0) indicated by black display width information 181 stored in the storage section 18. In a case where the distance comparison section 134 determines that the calculation result is larger than the value indicated by the black display width information 181, the distance comparison section 134 overwrites the black display width information 181 by the calculation result. On the other hand, in a case where the distance comparison section 134 determines that the calculation result is equal to or smaller than the value indicated by the black display width information 181 stored in the storage section 18, the distance comparison section 134 does not overwrite the black display width information 181. In other words, the distance comparison section 134 specifies a maximum distance between (i) a pixel that is determined by the matching pixel value determining section 132 as having a pixel value that matches a pixel value of a corresponding pixel and (ii) the left side I1 of the image for the left eye or the right side I2 of the image for the right eye.

Note here that the black display width information 181 indicates a value indicative of a maximum distance at the time of the comparison, which distance is a distance between a target pixel and the left side I1 or a distance between a target pixel and the right side I2. The maximum distance has been overwritten before the time of the comparison. At the time of completion of the detection process carried out by the parallax maximum width detection section 13 (i.e., when the image region specifying section 14 reads out the black display width information 181, in order to specify the first image region T1 and the second image region T2), the black display width information 181 indicates a value indicative of each of the widths (parallax maximum widths) of the first image region T1 and the second image region T2. Note that a parallax maximum width of the image for the left eye, may be referred to as a left maximum width, and a parallax maximum width of the image for the right eye may be referred to as a right maximum width.

The distance comparison section 134 notifies the target pixel selection section 131 of completion of the process carried out by the distance comparison section 134 (i) after the black display width information 181 is overwritten in a case where it is determined that the calculation result is larger than the value indicated by the black display width information 181 and (ii) after the determination in a case where it is determined that the calculation result is equal to or smaller than the value indicated by the black display width information 181.

As has been described, the parallax maximum width detection section 13 detects the parallax maximum width, thereby allowing the image region specifying section 14 to specify (i) the first image region T1 which, is defined based on the left side I1 and extends continuously from the upper side I3 to the lower side I4 or (ii) the second image region T2 which is defined based on the right side I2 and extends continuously from the upper side I3 to the lower side I4.

Upon reception of the notification indicating that the detection, process carried out by the parallax maximum width detection section 13 is completed from the target pixel selection section 131, the image region specifying section 14 reads out the black display width information 181 from the storage section 18 and specifies the first image region T1 and/or the second image region T2 illustrated in (b) of FIG. 5.

In a case where the left maximum width indicated by the black display width information 181 is larger than 0, the image region specifying section 14 specifies, as the first image region T1, a region extending continuously from the upper side I3 to the lower side I4 and having the left maximum width froth the left side I1 of the image for the left eye. Similarly, in a case where the right maximum width indicated by the black display width information 181 is larger than 0, the image region specifying section 14 specifies, as the second image region T2, a region extending continuously from the upper side I3 to the lower side I4 and having the right maximum width from the right side I2 of the image for the right eye.

On the other hand, the image region specifying section 14 does not specify the first image region T1 or the second image region T2 in a case where the left maximum width or the right maximum width indicated by the black display width information 181 is 0. That is, the image region specifying section 14 specifies at least the first image region T1 or the second image region T2.

In other words, the image region specifying section 14 determines, as a width from the left side I1 of the first image region T1 and a width from the right side I2 of the second image region T2, the maximum distance specified by the distance comparison section 134.

Note that content is constituted by a plurality of images. For example, some of the images (i) may include no near view object or (ii) may include a near view object but the near view object does not exist in the vicinities of left and right edges of these images. The image region specifying section 14 needs to specify neither the first image region T1 nor the second image region T2 (i.e., both the left maximum width and the right maximum width can be set to 0) for such images.

Further note that, although the first image region T1 and the second image region T2 each have a quadrangular shape in the present embodiment, the shape of each of these regions is not limited to this. For example, in a case of an image having a shape of a racetrack, each of the first and second image regions T1 and T2 can be (i) a region having a predetermined width from the first edge of the image for the left eye or from the second edge of the image for the right eye or (ii) a region enclosed by the first edge or the second edge and a line segment parallel with the short axis direction. Further, even in a case of the image having the quadrangular shape like the present embodiment, a line segment (line segment other than the left side I1, right side I2, upper side I3, and lower side I4) which defines the first image region T1 or the second image region T2 can be nonparallel with the short axis direction, and can be a curved line etc. Other than the image having the shape of the racetrack, the image can be for example an image that fits a curved display surface or an image that fits a flexible display.

Note however that, in a case where each of the first and second image regions T1 and T2 has a quadrangular shape, each of the first and second parallax images having the respective first and second image regions T1 and T2 also has a quadrangular shape. Therefore, a display screen of a display device (e.g., display device 40) in which the above images are displayed three-dimensionally should also have a quadrangular shape to achieve good display efficiency. In this case, such a display screen can be produced by obtaining its quadrangular substrate (panel) from a glass plate. That is, the substrate can be efficiently obtained from the glass plate. This makes it possible to increase mass productivity of not only the substrate but also mass productivity of the display screen and the display device.

Upon completion of the specification of the first image region T1 and/or the second image region T2, the image region specifying section 14 notifies the pixel value changing section 15 and the luminance value changing section 16 of the completion.

Upon reception of the notification from the image region specifying section 14, the pixel value changing section 15 changes a pixel value of at least one of the first and second image regions T1 and T2 specified by the image region specifying section 14 to a pixel value indicative of a predetermined pattern. Upon completion of change of the pixel value, the pixel value changing section 15 transmits, to the image output section 17, pixel information indicative of a changed pixel value of the image for the left eye and/or the image for the right eye.

Note here that the predetermined pattern is a figured pattern or a colored pattern etc. for preventing an object in the first image region T1 and/or the second image region T2 from being displayed. The pattern is for example a black-colored pattern, a pattern of a color similar to black, a pattern of fine stripes or a dot pattern. In the present embodiment, in order to surely suppress a reduction in a stereoscopic effect of the images displayed three-dimensionally, it is preferable that the predetermined pattern be a pattern of a single dark color, and particularly preferably a black-colored pattern. With the pattern of the single dark color (particularly black-colored, pattern), it is possible to surely suppress a reduction in a stereoscopic effect.

Note that this process of changing the pixel value to that indicative of a predetermined pattern can indicate (i) a process of removing the first image region T1 or the second image region T2 in the image output section 17 and (ii) a process of transmitting, to the image output section 17, notification for causing an output (e.g., display device 40) of the image output section 17 not to display the region.

The luminance value changing section 16 generates a luminance change instruction for at least increasing, in image regions other than the first image region T1 and/or the second image region T2 specified by the image region specifying section 14, a luminance value of a pixel of an object that exists in one of the parallax images and does not exist in the other. Specifically, upon reception of the notification by the image region specifying section 14, the luminance value changing section 16 instructs the target pixel selection section 131 to start a process to cause the parallax maximum width detection section 13 to generate the luminance value change pixel information 182. Upon reception of notification of completion of the process from the target pixel selection section 131, the luminance value changing section 16 reads out the luminance value change pixel information 182 from the storage section 18 and generates, as the luminance change instruction, (i) a pixel and (ii) a luminance value to which a current luminance value of the pixel is to be changed, which are indicated by the luminance value change pixel information 182.

Note here that, in a case where an object exists in one of the parallax images and does not exist in the other, the object does not overlap another object even when the parallax images are displayed three-dimensionally. On the other hand, in a case where an object exists in both the image for the right eye and the image for the left eye, objects in the respective images overlap each other when the images are displayed three-dimensionally. That is, when the images are displayed three-dimensionally, a pixel representing the object that exists in one of the parallax images and does not exist in the other has a luminance value up to about half as large as (about one to two times as small as) a luminance value of the object that exists in both of the parallax images.

In view of this, in order to prevent a reduction in image quality resulting from the reduction in the luminance value, the luminance value changing section 16 generates a luminance change instruction for at least increasing a luminance value (luminance values of a pixel in a right part of the image for the left eye and a pixel in a left part of the image for the right eye) of the object that exists only in one of the parallax images and transmits the luminance change instruction to the image output section 17.

Note that, since the pixel representing the object that exists in one of the parallax images and does not exist in the other has a luminance value up to about half as large as a normal value, the luminance value indicated by the luminance value change pixel information 182 is set to preferably about twice as large as (about one to two times as large as) a luminance value representing the object. The pixel whose luminance value is to be increased by the luminance value changing section 16 is not limited to the pixel indicated by the luminance value change pixel information 182. Alternatively, a luminance value(s) of the pixel indicated by the luminance value change pixel information 182 and/or an adjacent pixel can be increased by the luminance value changing section 16. Further, luminance gradation can be added to a boundary between (i) the pixel whose luminance value is increased and (ii) a pixel whose luminance value remains unchanged so that the region where luminance values are increased looks more natural to a viewer.

Upon reception of the image information indicative of changed pixel values of the image for the left eye and the image for the right eye from the pixel value changing section 15 and reception of the luminance change instruction from the luminance value changing section 16, the image output section 17 generates, in accordance with the image information, an image for a right eye and an image for a left eye which are to be outputted. The image output section 17 then supplies these images to a display device (e.g., display device 40) including a display screen, together with the luminance change instruction. This enables the display device to display, on the display screen, an image having been subjected to image processing by the image processing device 1. Further, the luminance change instruction controls light emitted from a backlight of the display device. This makes it possible to at least increase a luminance value of a pixel representing the object that exists in one of the parallax images and does not exist in the other.

Note that the image output section 17 can be configured to directly output the image information received from the pixel value changing section 15, without generating the image for the right eye and the image for the left eye serving as final display images from the image information. Further, the process of changing a luminance value by the luminance value changing section 16 is not essential. In a case where this process is omitted, the image processing device 1 does not have to include the luminance value changing section 16 as its constituent.

The storage section 18 stores therein (1) control programs for controlling various sections, (2) an OS program, (3) an application program, which are executed by the image processing control section 11, and (4) various data to be read out when the image processing control section 11 executes these programs. The image processing control section 11 is constituted by for example a nonvolatile storage device such as a ROM (Read Only Memory) flash memory. Note that, although the foregoing primary storage section is constituted by a volatile storage memory device such as a RAM, the present embodiment may be described on the assumption that the storage section 18 serves also as the primary storage section. In the storage section 18, for example the black display width information 181 or the luminance value change pixel information 182 etc. are stored.

Since the pixel value changing section 15 carries out the foregoing process, part of or an entire object behind a near view object that has a parallax equivalent to a width of the first image region T1 or of the second image region T2 is to be unnecessarily removed. Note, however, that such an object thus unnecessarily removed is always a distant view object, which is not shown to the viewer in an enhanced manner. Therefore, a feeling of strangeness given to the viewer is small.

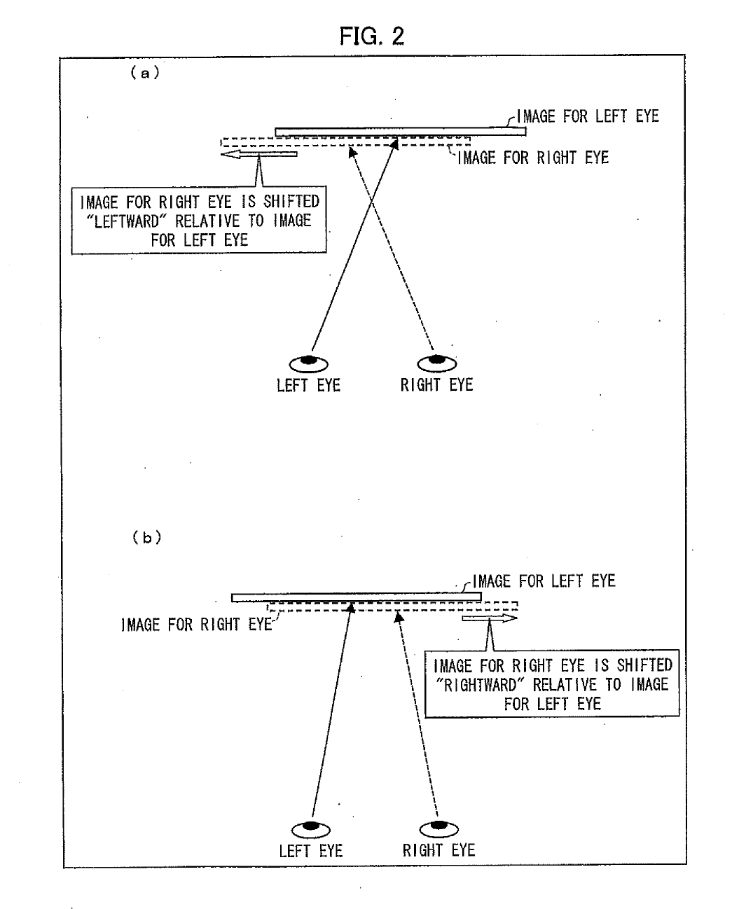

The phrase “unnecessarily removed” is specifically discussed below with reference to FIG. 2. FIG. 2 is a view illustrating a near view image and a distant view image. (a) of FIG. 2 illustrates how images are displayed as a near view image. (b) of FIG. 2 illustrates how images are displayed as a distant view image.

In a three-dimensional image, a near view object (which looks popping out at a viewer) is displayed in such a way that an image for a right eye is shifted “leftward” relative to an image for a left eye (see FIG. 2). That is, the viewer's eyes are focused on somewhere in front of a display screen, and the viewer is given an illusion that the near view object is popping out at the viewer. On the other hand, a distant view object (which looks receding in background) is displayed in such a way that an image for a right eye is shifted “rightward” relative to an image for a left eye. That is, the viewer's eyes are focused on somewhere behind the display screen, and the viewer has an illusion that the distant view object recedes in the display screen. Note that an actual image usually contains both a near view object and a distant view object (i.e., an image shifted rightward and an image shifted leftward are mixedly contained in one image).

For example, in (a) of FIG. 5, an airplane (object A and object A′) and a balloon (object C and object C′) are near view objects, and a mountain (object B and object B′) is a distant view object. In order to cause the airplane and the balloon to look popping out at the viewer, it is necessary to shift an image for a right eye “leftward” relative to an image for a left eye. Note here that, in a case where the near view object is in the vicinity of the center of the image, a reduction in a stereoscopic effect caused by the near view object existing only in either one of the images does not occur. However, in a case where the near view object (e.g., the airplane of (a) of FIG. 5) is in the vicinity of the left side of the image for the left eye, the near view object in the image for the right eye shifted “leftward” is to be out of a frame of the display screen. This applies also to the balloon. In a case where the balloon is in the vicinity of the right side I2 of the image for the right eye, the balloon in the image for the left eye is to be out of the frame of the display screen. This is because the image for the left eye is shifted rightward relative to the image for the right eye when the image for the right eye is shifted “leftward”.

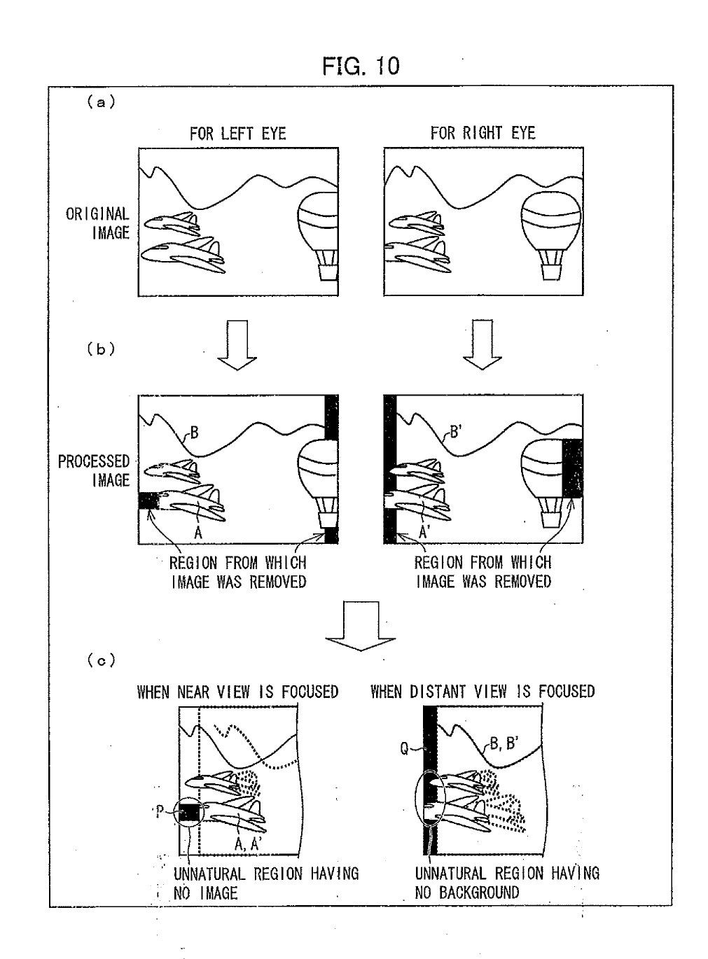

In order to solve a problem (i.e., problem in which an unnatural region having no image appears as illustrated in (c) of FIG. 10) of Patent Literature 1, the present invention is configured to (i) specify the first and second image regions T1 and T2 each of which extends continuously from the upper side I3 to the lower side I4 and (ii) change pixel values of these regions to pixel values indicative of a predetermined pattern (e.g., black display is caused in these regions). Needless to say, when the pixel values are changed, the mountain (i.e., distant vies object) in these regions is also removed (i.e., black display is caused).

As illustrated in (b) of FIG. 2, the mountain (i.e., distant view object) is subjected to shifting opposite to the shifting for the near view object (i.e., the image for the right eye is shifted “rightward” relative to the image for the left eye). Note here that, the present embodiment is arranged specially for the near view object, and is arranged such that the pixel values in the first and second image regions T1 and T2 are changed to pixel values indicative of a predetermined pattern so that an object in the image for the left eye and an object in the image for the right eye overlap each other. Accordingly, for the distant view object, a pixel value of the distant view object on a side on which no change in a pixel value is necessary is unnecessarily changed.

That is, if the processing is carried out with respect to a near view so that a near view object in the image for the left eye and a near view object in the image for the right eye overlap each other, a region where a distant view object in the image for the left eye and a distant view object in the image for the right eye cannot overlap each other will be increased in the distant view. That is, when the pixel value changing section 15 carries out the above process, part of or an entire object behind the near view object is “unnecessarily removed”. Note, however, that the object thus unnecessarily removed is the distant view object, which is not shown to the viewer in an enhanced manner. Therefore, a feeling of strangeness given to the viewer is small. In view of this, the processing arranged specially for the near view object like the present embodiment should be advantageous in solving the above problem.

### [Process by Image Processing Device]

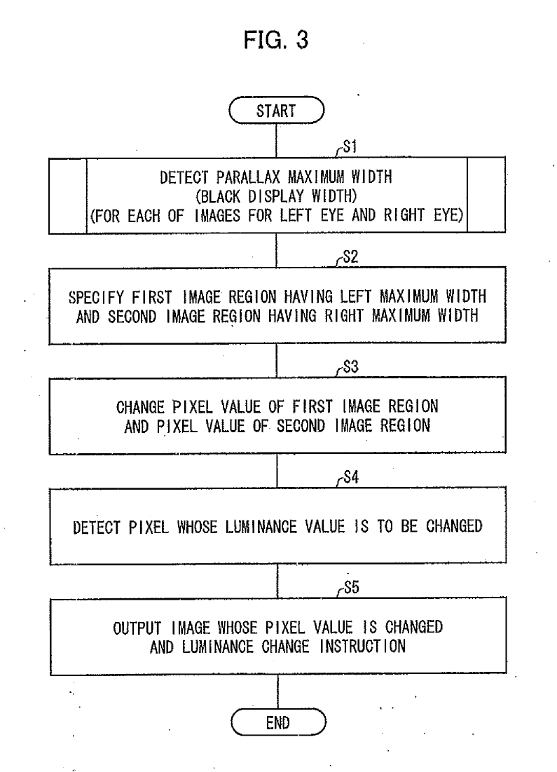

The following description discusses, with reference to FIGS. 3 through 5, an example of how a process is carried out by an image processing device and an example of an image during the process. Note that the details of the process are omitted here because these are already described earlier.

First, an example of an overall course of the process carried out by the image processing device 1 is described with reference to FIG. 3. FIG. 3 is a flowchart illustrating an example of how the image processing device 1 carries out the process.

After the image obtaining section 12 obtains a group of images serving as content, the parallax maximum width detection section 13 detects a parallax maximum width (black display width information 181) in each of images for a left eye and a right eye (S1).

After completion of the detection, the target pixel selection section 131 of the parallax maximum width detection section 13 transmits notification indicating that the detection is completed to the image region specifying section 14. Upon reception of the notification, the image region specifying section 14 (i) reads out the black display width information 181 from the storage section 18 and (ii) specifies the first image region T1 having a left maximum width specified by the black display width information 181 and the second image region T2 having a right maximum width specified by the black display width information 181 (S2). Note that, although both the first image region T1 and the second image region T2 are specified here, the first image region T1 is not specified if the left maximum width is 0, and the second image region T2 is not specified if the right maximum width is 0.

After specifying the first image region T1 and the second image region T2, the image region specifying section 14 notifies the pixel value changing section 15 and the luminance value changing section 16 of completion of the speciation. The pixel value, changing section 15 changes a pixel value of the first image region T1 and a pixel value of the second image region T2 to pixel values (e.g., pixel values indicative of a black display) indicative of a predetermined pattern (S3). The pixel value changing section 15 then transmits, to the image output section 17, image information indicative of, changed pixel values of the image for the left eye and the image for the right eye.

The luminance value changing section 16 instructs the parallax maximum width detection section 13 to generate the luminance value change pixel information 182, thereby causing the parallax maximum width detection section 13 to detect (generate the luminance value change pixel information 182) a pixel whose luminance is to be changed (S4). Upon reception of notification indicating that the process is completed from the parallax maximum width detection section 13, the luminance value changing section 16 generates a luminance change instruction for increasing a luminance value of a pixel indicated by the luminance value change pixel information 182 and transmits the luminance change instruction to the image output section 17.

Upon reception of the image information and the luminance change instruction from the pixel value changing section 15 and the luminance value changing section 16, respectively, the image output section 17 generates an image for a right eye and an image for a left eye which are for output and supplies, together with the luminance change instruction, these images to for example the display device 40 (S5). Then, the process by the image processing device 1 is completed.

The following description discusses, with reference to FIG. 4, how the process (process by the parallax maximum width detection section 13) of S1 of FIG. 3 is carried out. FIG. 4 is a flowchart illustrating an example of how the process is carried out by the parallax maximum width detection section 13. Note here that the following description discusses, with reference to FIG. 4, a process carried out by the parallax maximum width detection section 13 with respect to the image for the left eye. Note, however, that the parallax maximum width detection section 13 carries out the same processing also with respect to the image for the right eye. That is, the flowchart of FIG. 4 serves as a flowchart for the image for the right eye if the terms “left” in FIG. 4 are all changed to “right”.

First, the target pixel selection section 131 selects a target pixel from pixels on a left edge (left side I1) of an image for a left eye (S11). At the start of this process, for example a pixel at the upper left corner is selected by default. The target pixel selection section 131 notifies the matching pixel value determining section 132 of a position of the target pixel thus selected.

The matching pixel value determining section 132 determines whether or not a line of horizontally arranged pixels in an image for a right eye includes a pixel corresponding to the target pixel of the image for the left eye (S12). Whether or not the line of horizontally arranged pixels in the image for the right eye includes the pixel corresponding to the target pixel of the image for the left eye can be determined in the following manner. That is, an object to be processed in the present invention is a near view object. In order to display the near view object so that it is perceived by the viewer as being closer to the viewer than the display screen is, the image for the right eye is shifted leftward relative to the image for the left eye or the image for the left eye is shifted rightward relative to the image for the right eye. Therefore, whether or not there is a pixel indicative of a near view object and corresponding to the target pixel set in the image for the left eye can be determined by searching for a pixel corresponding to the target pixel within the image for the right eye while moving leftward from a position of the coordinate of the target pixel. On the other hand, whether or not there is a pixel indicative of a near view object and corresponding to the target pixel set in the image for the right eye can be determined by searching for a pixel corresponding to the target pixel within the image for the left eye while moving rightward from the position of the coordinate of the target pixel.

In a case where it is determined that there is the pixel corresponding to the target pixel (Yes in S12), the matching pixel value determining section 132 notifies the distance calculation section 133 of a determination result indicating that pixel values match. In a case where it is determined that there is no pixel corresponding to the target pixel (No in S12), the matching pixel value determining section 132 notifies the target pixel selection section 131 of a determination result indicating that pixel values do not match.

In the case where it is determined that there is no pixel corresponding to the target pixel (No in S12), the target pixel selection section 131 selects, as a new target pixel, an adjacent pixel on the right side of the current target pixel in the image for the left eye. Then, the target pixel selection section 131 again notifies the matching pixel value determining section 132 of a position of the new target pixel (S13), and returns to the process of S12.

In the process of S13, pixel values of the left half or more of the image for the left eye or pixel values of the right half or more of the image for the right eye may not match (i.e., an object in one image is different from an object in the other) depending on the content, by the content producer's intention. In such a case, if the processes of S12 through S16 are carried out, then a black display will be caused in an almost entire display. This may result in an image that the viewer can hardly see. In addition, in a case of the image for the left eye, an object in the vicinity of the left side I1 is the near view object. Taking into account that a reduction in a stereoscopic effect is more noticeable as an object becomes closer to the near view, it is not necessary to carry out the processes of S12 through S16 for pixels on the right side I2 side. In view of this, for example, it is preferable that pixels in a region to the center (in the long axis direction) of the image be set as pixels to be selected as target pixels. Alternatively, instead of the center of the image, it is preferable that pixels in a region to a predetermined position (in the long axis direction) of, the image be pixels to be selected as target pixels.

On the other hand, in the case where it is determined that there is a pixel corresponding to the target pixel (Yes in S12), the distance calculation section 133 calculates a distance from the left side I1 to the target pixel, and transmits a calculation result to the distance comparison section 134 (S14). The distance comparison section 134 determines whether or not the calculation result is larger than the left maximum width (black display width information 181) stored (recorded) in the storage section 18 (S15).

In a case where it is determined that the calculation result is larger than the left maximum width stored in the storage section 18 (Yes in S15), the distance comparison section 134 stores, as a new left maximum width, the calculation result of S14 in the storage section 18 (S16). Then, the distance comparison section 134 notifies the target pixel selection section 131 of completion of the process. On the other hand, in a case where it is determined that the calculation result is smaller than or equal to the left maximum width stored in the storage section 18 (No in 815), the distance comparison section 134 carries out nothing and notifies the target pixel selection section 131 of the completion of the process.

Upon reception of the notification, the target pixel selection section 131 determines whether or not all of the pixels on the left edge have been checked (i.e., subjected to the processes of S12 through S16) (S17). For example in a case where (i) a pixel at the upper left corner is selected as a target pixel by default and (ii) subsequent pixels are selected as a target pixel one by one in a downward direction and determined whether or not there is a pixel corresponding to the target pixel, the process of S17 determines whether or not the undermost pixel has been checked for whether or not there is a pixel corresponding to the target pixel. Further, for the same reason as in the process of S13, it is preferable in the target pixel selection section 131 that pixels in a region to the center (in the long axis direction) of the image be set as pixels to be selected as target pixels. Alternatively, instead of the center of the image, it is preferable that pixels in a region to a predetermined position (in the long axis direction) be pixels to be selected as target pixels.

The processes illustrated in FIG. 4 enable the parallax maximum width detection section 13 to store, in the storage section 18, the black display width information 181 (parallax maximum width) to be read out by the image region specifying section 14.

The following description discusses, with reference to FIG. 5, an example of how the image processing device 1 carries out image processing (processes of FIG. 3 and FIG. 4). FIG. 5 illustrates an example of how the image processing device 1 carries out image processing. (a) of FIG. 5 is a view illustrating an original image not processed by the image processing device 1. (b) of FIG. 5 is a view illustrating an image obtained from the original image through the processing by the image processing device 1. (c) of FIG. 5 is a view illustrating how the images of (b) of FIG. 5 are displayed three-dimensionally.

Assume that an original image for a right eye and an original image for a left eye obtained by the image obtaining section 12 are images illustrated in (a) of FIG. 5. First, the processes of S1 and S2 of FIG. 3 are carried out. That is, the image region specifying section 14 specifies, as the first image region T1 and the second image region T2, a region where pixel values of the respective images for the left eye and the right eye are different from each other. Note that the following description is based on the assumption that the image for the left eye and the image for the right eye of (a) of FIG. 5 each include an object that exists in one of parallax images but does not exist in the other.

Next, the process of S3 (i.e., process carried out by the pixel value changing section 15) is carried out. This causes the image output section 17 to output an image for a right eye and an image for a left eye (i.e., images obtained through the process of S3) as illustrated in (b) of FIG. 5.

Note here that, in a case where a user who views an image displayed on an output (e.g., display device 40) focuses on a near view (see (c) of FIG. 5), an object A of the image for the right eye and an object A′ of the image for the left eye (objects A and A′ each represent an identical airplane) illustrated in (b) of FIG. 5 are in focus. In the image processing device 1, the image region specifying section 14 specifies, as each of the first and second image regions T1 and T2, a region having a predetermined width (parallax maximum width) and extending continuously from the upper side I3 to the lower side I4. Accordingly, it is possible to cause a black display in a vertically-arranged region when the pixel value changing section 15 changes a pixel value of each of the above regions to a pixel value indicative of a predetermined pattern (see (b) of FIG. 5).

That is, after the processing is carried out by the image processing device 1, no unnatural image appears and no near view object overlaps a frame of the display screen either in a case where the viewer focuses on the near view or in a case where the viewer focuses on a distant view (see (c) of FIG. 5). According to Patent Literature 1, a part where objects of the respective images are different from each other only is removed from the image for the left eye and the image for the right eye (see (b) of FIG. 10). This results in unnatural regions P and Q where no image is displayed, and causes a reduction in a stereoscopic effect. According to the present embodiment, no such unnatural region appears (see (c) of FIG. 5). This prevents a reduction in a stereoscopic effect, and thus makes it possible to provide a viewer with content with good image quality.

As described above, the image processing device 1 (and a method for controlling the same) includes (i) the image region specifying section 14 (step of specifying image region) for specifying at least one of the first and second image regions T1 and T2 and (ii) the pixel value changing section 15 (step of changing pixel value) for changing a pixel value of at least one of the first and second image regions T1 and T2 specified by the image region specifying section 14 to a pixel value indicative of a predetermined, pattern. Note here that the first image region T1 is an image region (a) including an object that exists in the image for, the left eye and does not exist in the image for the right eye and (b) being defined based on the left side I1 of the image for the left eye and extending continuously from the upper side I3 to the lower side I4. Further, the second image region T2 is an image region (c) including an object that exists in the image for the right eye and does not exist in the image for the left eye and (d) being defined based on the right side I2 of the image for the right eye and extending continuously from the upper side I3 to the lower side I4.

The configuration makes it possible not only to remove objects that do not match each other from the respective images for the left eye and the right eye (see (b) of FIG. 10), but also to change pixel values in regions including the respective objects to pixel values indicative of a predetermined pattern. This makes it possible to prevent unnatural regions having no image (see (c) of FIG. 10) from appearing during three-dimensional display, and thus possible to suppress a reduction in the stereoscopic effect.

### [Example of Application of Image, Processing Device 1]

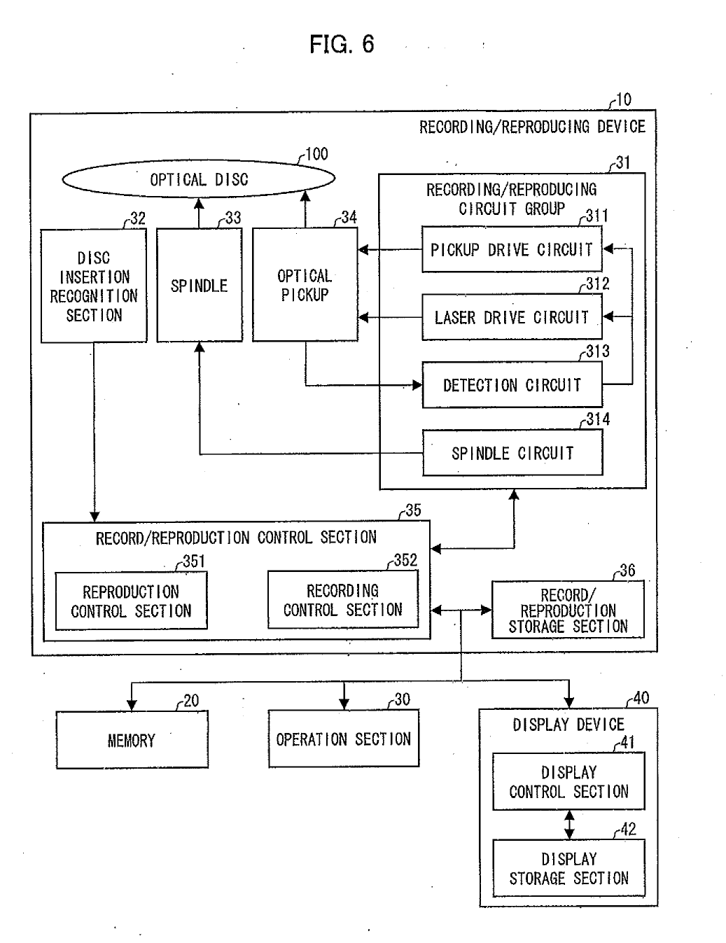

The following description discusses, with reference to FIG. 6, an example of application of the image processing device 1. FIG. 6 is a view illustrating an example of schematic configurations of the recording/reproducing device 10 and the display device 40, each of which has a main part of the configuration of the image processing device 1. The following description is based on the assumption that the recording/reproducing device 10 and the display device 40 each have a function of the image processing device 1. Note, however, that only either the recording/reproducing device 10 or the display device 40 can have the function of the image processing device 1. Alternatively, the recording/reproducing device 10 and the display device 40 can be configured such that both of them do not have the function of the image processing device 1 and are connected with the image processing device 1.

According to FIG. 6, the recording/reproducing device 10 and the display device 40 are connected with each other. Note, however, that they can be independent of each other. In this case, (i) the recording/reproducing device 10 and the display device 40 each have the function of the image processing device 1 or (ii) the recording/reproducing device 10 and the display device 40 are each connected with the image processing device 1.

As illustrated in FIG. 6, the recording/reproducing device 10 functions as (i) a reproducing device that carries out reproduction control with respect to an optical disc (information recording medium) in which an image whose pixel value is changed by the image processing device 1 is recorded and/or (ii) a recording device that carries out recording control with respect to the optical disc in which the image whose pixel value is changed by the image processing device 1 is recorded. The recording/reproducing device 10 is not limited to these, and can be (a) a reproducing device that carries out reproduction control with respect to an optical disc (generally known conventional optical disc) in which an image whose pixel value is not changed by the image processing device 1 is recorded or (b) a recording device that carries out recording control with respect to an optical disc (e.g., an optical disc (blank disc) in which no information is recorded) in which an image whose pixel value is changed can be recorded. Note that each of these optical discs can be the optical disc 100 in a case Where the image whose pixel value is not changed by the image processing device 1 is recorded in the optical disc 100 or is a blank disc.

The recording/reproducing device 10 does not necessarily have to include (i) a recording control section 352 (recording control means, described later) in a case where it functions as a reproducing device and (ii) a reproduction control section 351 (reproduction control means, described later) in a case where it functions as a recording device. The recording/reproducing device 10 is capable of carrying out the recording control or reproduction control of an optical disc, which is not limited to the optical disc 100 (described later) and can be a general optical disc (e.g., optical disc satisfying the DVD standard or optical disc satisfying the Blu-ray© standard). The following description is mainly based on the assumption that the optical disc is the optical disc 100. A schematic configuration of the optical disc 100 is described later.

The recording/reproducing device 10 mainly includes a recording/reproducing circuit group 31, a disc insertion recognition section 32, a spindle 33, an optical pickup 34, a record/reproduction control section 35 and a record/reproduction storage section 36.

The spindle 33 holds the optical disc 100 and causes the optical disc 100 to rotate.

The disc insertion recognition section 32 detects a state in which the optical disc 100 is inserted, and is for example various sensors. The disc insertion recognition section 32 can be any sensor provided that it is capable of detecting the state in which the optical disc 100 is inserted. The disc insertion recognition section 32 is adapted to output, as a detection signal, a detection result to the record/reproduction control section 35.

The record/reproduction storage section 36 stores therein (1) control programs for various sections, (2) an OS program and (3) an application program, which are to be executed by the record/reproduction control section 35 and (4) various data to be read out when these programs are executed. The record/reproduction storage section 36 is constituted by a nonvolatile storage device such as for example a ROM (Read Only Memory) flash memory. In the record/reproduction storage section 36, (i) content including an image whose pixel value is changed by the image processing device 1, (ii) content read out from an optical disc (in a case of the optical disc 100, content including an image whose pixel value is changed by the image processing device 1), or the like is stored. Further, the black display width information 181, the luminance value change pixel information 182, and the like stored in the storage section 18 are also stored in the record/reproduction storage section 36, because the recording/reproducing device 10 has the function of the image processing device 1.

The recording/reproducing circuit group 31 is for driving the spindle 33 and the optical pickup 34 etc., and mainly includes a pickup drive circuit 311, a laser drive circuit 312, a detection circuit 313 and a spindle circuit 314.

The pickup drive circuit 311 causes the entire optical pickup 34 to move to a position in the optical disc 100 at which position recording or reproduction is desired to begin. The pickup drive circuit 311 further causes an actuator (not illustrated) inside the optical pickup 34 to operate, for the purpose of controlling focusing and tracking at the position.

The laser drive circuit 312 causes a laser (not illustrated) inside the optical pickup 34 to operate so that intensity of light that strikes the optical disc 100 is suitable for recording or reproduction.

The detection circuit 313 detects light reflected by the optical disc 100, and mainly generates, for the focusing and tracking, a servo signal to be fed back to the pickup drive circuit 311 and an RF signal including information on the optical disc 100. Further, the detection circuit 131 detects light reflected by part of the optical pickup 34 and generates a servo signal to be fed back to the laser drive circuit 312 so as to keep intensity of light emitted from the optical pickup 34 constant.

The spindle circuit 314 causes the spindle 33, i.e., the optical disc 100, to rotate at an optimum speed when instructed by the record/reproduction control section 35 to drive the spindle 33. Specifically, the record/reproduction control section 35 instructs the spindle circuit 314 to drive the spindle 33 upon reception of (i) a detection signal from the disc insertion recognition section 32 or (ii) an instruction (e.g., reproduction instruction) inputted via an operation section 30 (described later).

The optical pickup 34 is an optical system that (i) converges light emitted from the laser on the optical disc 100 and (ii) separates light reflected by the optical disc 100 so as to guide separated light to the detection circuit 313.

The record/reproduction control section 35 mainly includes (i) the image processing control section 11 (not illustrated) of the image processing device 1, (ii) the reproduction control section 351 and (iii) the recording control section 352. The record/reproduction control section 35 controls constituents of the recording/reproducing device by executing for example a control program. The record/reproduction control section 35 reads out a program from the record/reproduction storage section 36, loads the program to a primary storage section (not illustrated) constituted by for example a RAM (Random Access Memory), and executes the program. This achieves various processes such as image processing with respect to an obtained image for a left eye and an obtained image for a right eye and reproduction control or recording control with respect to the optical disc 100. The description of the process carried out by the image processing control section 11 is omitted here because it has already been described earlier.

The reproduction control section 351 carries out reproduction control with respect to an inserted optical disc. For example, the reproduction control section 351 carries out reproduction control with respect to the optical disc 100 in which an image whose pixel value is changed by the image processing device 1 is recorded. This makes it possible to cause the display device 40 to display content including the image subjected to image processing by the image processing device 1.

The reproduction control section 351 can be configured to reproduce an image whose pixel value is not changed by the image processing device 1. In such a case, even if an image (i.e., conventionally known general image for three-dimensional display) whose pixel value is not changed by the image processing device 1 is recorded in the optical disc, it is possible to provide to a viewer a three-dimensional image having no unnatural regions (see (c) of FIG. 10) in such a manner that the reproduction control section 351 reproduces such an image and the image processing device 1 orderly carries out processes of the image processing with respect to the image (e.g., image processing is carried out in real time during reproduction).

In other words, the reproduction control section 351 reproduces at least (i) an image whose pixel value is changed by the image processing device 1, which image is recorded in the optical disc 100 or (ii) an image whose pixel value is not changed by the image processing device 1, which image is recorded in a general optical disc.

The recording control section 352 carries out recording control with respect to an inserted optical disc. For example, the recording control section 352 carries out recording control with respect to the optical disc 100 in which an image whose pixel value is changed by the image processing device 1 is recorded. This makes it possible to record content to the optical disc 100, which content includes an image processed by the image processing device 1 or by the image processing control section 11 of the recording/reproducing device 10.

The recording control section 352 can be configured to record, to an optical disc (e.g., blank disc), an image whose pixel value is changed by the image processing device 1. In this case, it is possible to store, in the optical disc, an image whose pixel value is changed by the image processing device 1. Therefore, even if the display device 40 and/or the recording/reproducing device 1 do/does not include the image processing device 1, it is possible to provide to the viewer a three-dimensional image having no unnatural regions (see (c) of FIG. 10) merely by reading out the image.

Further, since the record/reproduction control section 35 includes the image processing control section 11, the record/reproduction control section 35 is capable, without being connected with the image processing device 1, of generating content including an image in which a reduction in a stereoscopic effect is suppressed, in the same manner as in the image processing device 1. The record/reproduction control section 35 is further capable of reading out content from an optical disc, carrying out the processing of the image processing control section 11 with respect to an image of the content, and recording the content to the optical disc or another optical disc.

The foregoing description discussed the recording/reproducing device 10. Note here that, generally, the recording/reproducing device 10 additionally has a memory 20, an operation section 30, a display device 40 or the like. In this case, the record/reproduction control section 35 of the recording/reproducing device 10 carries out overall operations not only within the recording/reproducing device 10 but also in an external device such as the memory 20, the operation section 30 or the like. The following description discusses such external devices. Note that the memory 20, the operation section 30, and the display device 40 etc. can be installed inside the recording/reproducing device 10.

The memory 20 functions as an external (removable) auxiliary storage device, and is for example a USB (Universal Serial Bus) memory or HDD. It is possible to store, in the memory 20, part of various programs and data stored in the record/reproduction storage section 36. The memory 20 is not limited to this, and can be constituted by for example a RAM. The memory 20 can be the one in which information read out from a ROM layer, RE layer, or R layer of the optical disc 100 or externally obtained information etc. are temporarily stored.

The operation section 30 is the one via which a user inputs an instruction signal for causing the recording/reproducing device 10 to operate. The operation section 30 is constituted by for example a remote controller that controls the recording/reproducing device 10 at a distance, a manual operation button installed in the recording/reproducing device 10 itself, or a mouse or keyboard connected with the recording/reproducing device 10. The instruction signal inputted by the user via the operation section 30 is transmitted to the foregoing functional blocks via an input/output control section (not illustrated). This enables the user to control the recording/reproducing device 10.

The display device 40 is capable of carrying out a three-dimensional display, and includes for example an LCD (liquid crystal display), PDP (plasma display panel), or CRT (cathode-ray tube) display. The display device 40 further includes, for the purpose of achieving a three-dimensional display, mainly a display control section 41 and a display storage section 42.

The display control section 41 includes mainly the image processing control section 11 (not illustrated), and controls constituents of the display device 40 by executing for example a control program. The display control section 41 reads out a program from the storage section 18, loads the program to a primary storage section (not illustrated) constituted by for example a RAM (Random Access Memory), and executes the program. This achieves various processes such as image processing with respect to an obtained image for a left eye and an obtained image for a right eye and a process of displaying an image on a display screen.

The display screen of the display device 40 should be capable of displaying an image whose pixel value is changed by the image processing device 1, because the display control section 41 includes the image processing control section 11.

The display storage section 42 storing therein (1) control programs for controlling various sections, (2) an OS program, (3) an application program, which are executed by the display control section 41, and (4) various data to be read out when these programs are executed. The display storage section 42 is constituted by a nonvolatile storage device such as for example a ROM (Read Only Memory) flash memory. In the display storage section 42, content including an image whose pixel value is changed by the image processing device 1 or by the recording/reproducing device 10 (display device 40) is stored. Further, the black display width information 181, the luminance value change pixel information 182, and the like stored in the storage section 18 are also stored in the display storage section 42, because the display device 40 has the function of the image processing device 1.

The above configuration allows the display device 40 to generate, without being connected with the image processing device 1, content including an image in which a reduction in the stereoscopic effect is suppressed, in the same manner as in the image processing device 1.

### [Configuration of Optical Disc 100 for Use in Recording/Reproducing Device 10]

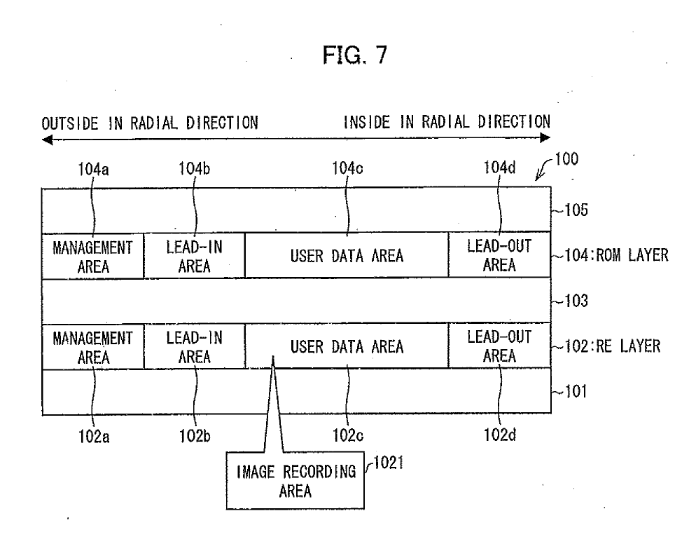

The following description discusses, with reference to FIG. 7, a schematic configuration of recording layers of the optical disc 100. FIG. 7 is a view illustrating an example of a schematic configuration of the recording layers of the optical disc 100. Note that, in the following description, layers of the optical disc 100 are referred to as follows: a reproduction-only recording layer is a ROM (Read Only Memory) layer; a rewritable recording layer is a RE (RE-writable) layer; and a write-once-read-many recording layer is a R (Recordable) layer.

As illustrated in FIG. 7, the optical disc 100 is constituted by stacking a substrate 101, a RE layer 102, an intermediate layer 103 made from transparent resin, a ROM layer 104, and a cover layer 105 in this order. Generally, reproduction light enters from the cover layer 105.

The RE layer 102 has a BCA area (management area) 102a, a lead-in area 102b, a user data area 102c, and a lead-out area 102d. Similarly, the ROM layer 104 has a BCA area (management area) 104a, a lead-in area 104b, a user data area 104c, and a lead-out area 104d.

FIG. 7 is based on the assumption that the optical disc 100 includes one (1) RE layer 102 and one (1) ROM layer 104. Note, however, that the optical disc 10 can be configured to have a plurality of RE layers 102 and a plurality of ROM layers 104. In other words, the optical disc 100 includes at least (i) a ROM layer 104 in which only reading out of information is permitted and (ii) an R layer or RE layer 102 in which recording or rewriting of information is permitted. Further, the order in which the RE layer 102 and the ROM layer 104 are stacked is not limited to the order illustrated in FIG. 7, and can be any order.

According to FIG. 7, there is the BCA area both in the RE layer 102 and the ROM layer 104. Note, however, that the BCA area can exist only in either one of the layers.

Each of the BCA areas 102a and 104a is located innermost in a radial direction in the optical disc 100, and is a recording area where no tracking control is needed or is a bar code recording area accessible only by focus control. The BCA, areas 102a and 104a each have a mark shape dramatically larger than a general recording mark in which information such as content is recorded, and information in the BCA areas 102a and 104a cannot be rewritten by a normal recording/reproducing device. That is, the BCA areas 102a and 104a are areas to which it is possible to write information only during production (that is, areas where information cannot be rewritten). An order in which pieces of identification information are recorded (or arranged) in the BCA areas 102a and 104a is specified by the normal standards etc. The recording/reproducing device 10 is designed such that, when the optical disc 100 is inserted, information in the BCA areas 102a and 104a is to be read out first.

In the BCA areas 102a and 104a, common medium information which is common to a plurality of optical discs 100 is recorded. Specific examples of the common medium information include types (e.g., reproduction-only type, write-once-read-many type, rewritable type) of recording layer of the optical disc 100, size of the optical disc 100, and a version of the standard of the optical disc 100. Further, unique medium information unique to each optical disc 100 is recorded in the BCA areas 102a and 104a.

The lead-in areas 102b and 104b are located outermost in the radial direction in the optical disc 100, and are located in respective recording layers on the outer side of the BCA areas 102a and 104a. Each of the lead-in areas 102b and 104b has an area (i.e., area where information cannot be rewritten) in which information can be written only during production. In a case of a write-once-read-many type or a rewritable type, each of the lead-in areas 102b and 104b further has an area where recording or rewriting information is allowed after the optical disc 100 is inserted into the recording/reproducing device 10. In the lead-in areas 102b and 104b, for example normal conditions of recording/reproduction of the optical disc 100, information indicative of permission or prohibition (access control) of access to each layer by the recording/reproducing device 10, information indicative of a defect at the time of production and/or a defect during use, or the like are recorded.

The user data areas 102c and 104c are areas in which various information such as basic software, e.g., OS (Operating System), application or content, and user data (personal information) associated with such various information are recorded (or can be recorded). Further, management information such as a location/address where such information is recorded and correlation (route of file or directory) between pieces of information are recorded.

According to the present embodiment, an application and content etc. prepared by a disc supplier are recorded in the user data area 104c of for example the ROM layer 104. The content can be images for a left eye and a right eye having pixel values changed by the image processing device 1. In such a case, a viewer can view content including an image in which a reduction in a stereoscopic effect is suppressed, merely by purchasing and playing back the optical disc 100. Note here that the images for the right eye and the left eye whose pixel values are not changed by the image processing device 1 can be recorded in the user data area 104c of the ROM layer 104. Alternatively, the optical disc 100 can be a blank disc in which nothing is recorded.

In the user data area 104c, an image processing program (control program for the image processing device 1) for achieving the image processing by the image processing control section 11 can be recorded. In this case, even if the recording/reproducing device 10 does not have the function of the image processing device 1, the recording/reproducing device 10 is capable of carrying out the function of the image processing device 1 merely by reading out the image processing program.

On the other hand, the user data area 102c of the RE layer 102 has an image recording area 1021 to which at least (i) an image whose pixel value is changed by the image processing device 1 (or the recording/reproducing device 10 having the function of the image processing device 1) or (ii) an image whose pixel value is not changed by the image processing device 1 is recorded.

This makes it possible to record the image whose pixel value is changed by the image processing device 1 to the image recording area 1021 of the optical disc 100. Further, when reproduction control is carried out with respect to the optical disc 100, it is possible to reproduce the above image. This makes it possible to provide, to the viewer, content including an image in which a reduction in a stereoscopic effect is suppressed.

It is also possible to record, to the image recording area 1021, the image whose pixel value is not changed by the image processing device 1. This enables the image processing device 1 (or the recording/reproducing device 10 or display device 40 having the function of the image processing device 1) to carry out image processing with respect to the image by causing for example the recording/reproducing device 10 to read out the image. Therefore, even in this case, it is possible to provide, to the viewer, an image in which a reduction in a stereoscopic effect is suppressed.

Further, for example the recording/reproducing device 10 is to reproduce the image recorded in the optical disc 100, which image has a pixel value changed in advance. Accordingly, it is not necessary to change pixel values every time the image is to be reproduced.

The lead-out areas 102d and 104d are located outermost in the radial direction in respective layers of the optical disc 100, and are indicative of ends of the recording layers.

As has been described, the optical disc 100 has at least (i) the R layer or RE layer 102 (recordable area) and (ii) the ROM layer 104 (reproduction-only area). The R layer or RE layer 102 has the image recording area 1021 in which at least (a) an image (processed image) whose pixel value is changed by the image processing device 1 or (b) an image (image that is not processed) whose pixel value is not changed by the image processing device 1 is recorded. On the other hand, in the ROM layer 104, the image processing program is recorded.

According to the configuration, it is possible collectively store (in one (1) information recording medium) the image processing program and an image that is not processed and is to be processed by the image processing program. Therefore, for example even in a case of reproducing device having no image processing program, it is possible to carry out image processing of the image processing device 1 with respect to the image by causing the reproducing device to read out the image processing program and the image that is not processed from the optical disc 100 when the optical disc 100 is inserted. As such, it is possible, by using the optical disc 100, to prevent a reduction in a stereoscopic effect during three-dimensional display.

Further, it is possible to collectively store (in (1) information recording medium) the image processing program and a processed image. For example, in a case where an optical disc in which the image processing program is recorded does not have the image recording area 1021 and the reproducing device does not have the image processing program, a user (viewer) needs to (i) take out the optical disc after the image processing program is read out from the optical disc and then (ii) insert another optical disc having a recordable area to which a processed image can be recorded so as to record the processed image to the optical disc. In this regard, the optical disc 100 is capable of collectively storing therein the image processing program and the processed image. Therefore, even if the optical disc, 100 is inserted into a reproducing device having no image processing program, the user does not need to change optical discs like above because the image processing program recorded in the optical disc 100 is usable and the processed image can be recorded to the optical disc 100. This makes it possible to reduce the burden on the user and improve convenience of optical discs.

The foregoing description discussed the optical disc 100. Note here that examples of the optical disc 100 include optical discs complying with the DVD standard or the Blu-ray© standard, such as: recordable discs (DVD-R, DVD-RW, DVD-RAM, DVD-R DL) for CPRM and DVD-ROM discs which comply with the DVD standard; and recordable discs (BD-RE, BD-R) and BD-ROM discs which comply with the Blu-ray© standard. Further note that, although the foregoing description discussed a configuration in which the optical disc 100 has the RE layer 201, the optical disc 100 is not limited to this configuration. The optical disc 100 can be configured to have only the ROM layer 104.

Further, the aforementioned optical disc 100 has (i) the R layer or RE layer 102 and (ii) the ROM layer 104. That is, the optical disc 100 is configured to realize function's of a reproduction-only area and a recordable area by the respective layers. Note, however, that the optical disc 100 can be configured to have both the reproduction-only area and the recordable area in one (1) layer.

### [Modification of Image Processing Device 1]

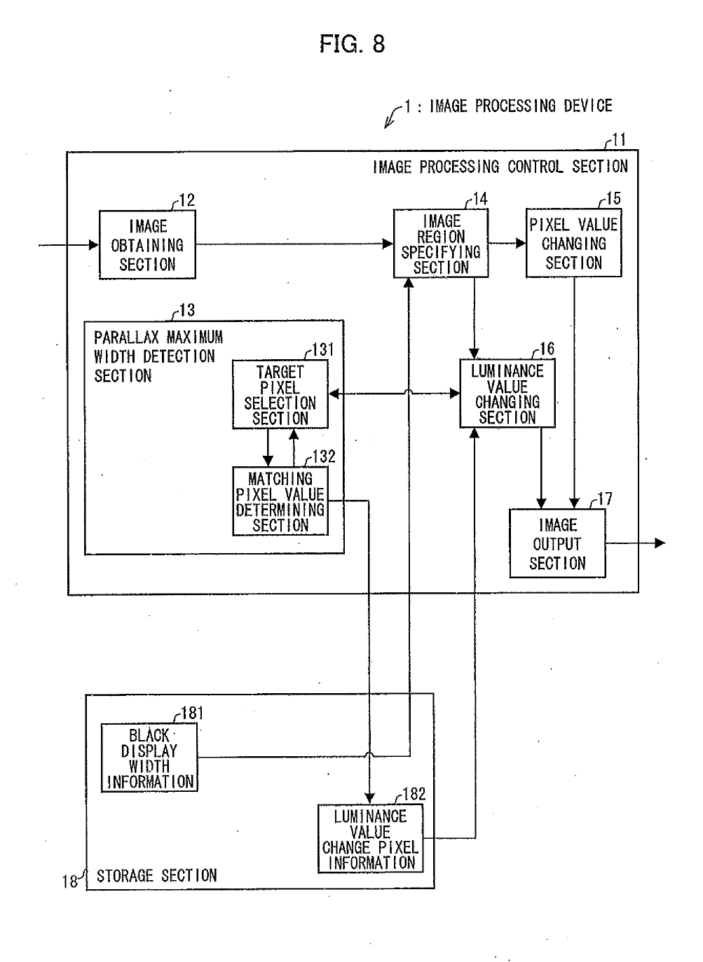

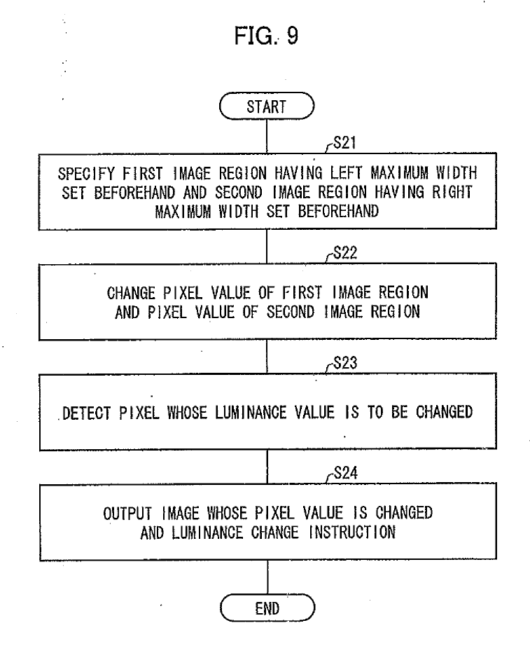

The following description discusses, with reference to FIGS. 8 and 9, a modification of the image processing device 1. FIG. 8 is a block diagram illustrating an example of how a main part of the image processing device 1 serving as a modification is configured. FIG. 9 is a flowchart illustrating an example of how processes are carried out by the image processing device 1 serving as a modification.

According to the aforementioned image processing device 1, the image region specifying section 14 specifies the first image region T1 and/or the second image region T2 in accordance with the black display width information 181 obtained through the process of FIG. 4 carried out by the parallax maximum width detection section 13. On the other hand, according to the modification, the image region specifying section 14 specifies the first image region T1 and/or the second image region T2 in accordance with black display width information 181 that is set beforehand. In this case, the black display width information 181 can be (i) set beforehand by a content provider according to the content or (ii) set beforehand by the image processing device 1. In a ease where the black display width information 181 is set by the content provider, the black display width information 181 is obtained as information accompanied with the content and is stored in the storage section 18.

The image processing control section 11 includes functional blocks that are the same as those of the foregoing image processing device 1, except that the image processing control section 11 does not include the distance calculation section 133 and the distance comparison section 134. The reason therefor is as follows. The distance calculation section 133 and the distance comparison section 134 are functional blocks used only for generation of the black display width information 181. Since the black display width information 181 is set beforehand in the modification, such functional blocks are not necessary. In the storage section 18, information same as the information as in the foregoing image processing device 1 is stored.

According to the modification, the image obtaining section 12 obtains (i) content including an image for a right eye and an image for a left eye and then (ii) transmits the content to the image region specifying section 14. The image region specifying section 14 reads out the black display width information 181 stored beforehand in the storage section 18, and specifies a first image region T1 and a second image region T2. That is, the image region specifying section 14 specifies (i) the first image region T1 having a left maximum width set beforehand and (ii) the second image region T2 having a right maximum width set beforehand (S21). In a case where the left maximum width is 0, the first image region T1 is not specified. In a case where the right maximum width is 0, the second image region T2 is not specified. That is, according to the modification, the parallax maximum width detection section 13 generates only the luminance value change pixel information 182 and does not generate (detect) the black display width information 181.

The description for the subsequent processes S22 through S24 is omitted here, because these are the same as the processes of S3 through S5 of FIG. 3.

As has been described, according to the modification, a width from the left side I1 of the first image region T1 and a width from the right side I2 of the second image region T2 are set beforehand. Therefore, it is not necessary to determine the width (i.e., specify the first image region T1 or the second image region T2) for each image. This makes it possible to simplify the process carried out by the image region specifying section 14, and thus possible to improve a processing speed of the entire device.

In a case where (i) the image processing device 1 carries out processing with respect to content consisting of two or more images and (ii) the content is distributed in real time, it is necessary to carry out image processing (processes carried out by the image region specifying section 14 and the pixel value changing section 15) along with such content distribution. In this case, if a delay occurs in the image processing, then an image displayed three-dimensionally may have a flicker.

In this regard, since the width is set beforehand, it is possible to prevent such a delay from occurring in the image processing. Therefore, the modification is particularly suitable for a case where the image processing is carried out with respect to the content distributed in real time.

### [Another Way of Describing the Present Invention]

The present invention can be described also as below.

An image processing device in accordance with the present invention preferably further includes: matching pixel value determining means for determining (i) whether or not a pixel value of a target pixel of the first parallax image matches a pixel value of a corresponding pixel of the second parallax image at a position corresponding to the target pixel of the first parallax image and (ii) whether or not a pixel value of a target pixel of the second parallax image matches a pixel value of a corresponding pixel of the first parallax image at a position corresponding to the target pixel of the second parallax image; and maximum distance specifying means for specifying a maximum distance between (a position of the target pixel whose pixel value is determined by the matching pixel value determining means to match the pixel value of the corresponding pixel and (b) the first edge of the first parallax image or the second edge of the second parallax image, the image region specifying means determining that a width from the first edge of the first image region and a width from the second edge of the second image region are each the maximum distance specified by the maximum distance specifying means.

According to the configuration, the matching pixel value determining means determines (i) whether or not a pixel value of a target pixel of the first parallax image matches a pixel value of a pixel of the second parallax image at a position corresponding to the target pixel of the first parallax image and (ii) whether or not a pixel value of a target pixel of the second parallax image matches a pixel value of a pixel of the first parallax image at a position corresponding to the target pixel of the second parallax image. The maximum distance specifying means specifies, in a case where it is determined that pixel values match, (a) a maximum distance between a position of a pixel determined as having a pixel value that matches a pixel value of a corresponding pixel and the first edge of the first image region or (b) a maximum distance between a position of a pixel determined as having a pixel value that matches a pixel value of a corresponding pixel and the second edge of the second image region.

This enables the image region specifying means to specify (i) the first image region defined based on the first edge and extending continuously from the third edge to the fourth edge or (ii) the second image region defined based on the second edge and extending continuously from the third edge to the fourth edge.

Note here that, as described earlier, in a case where (i) a near view object in a region on the first-edge side is not the same between the first and second parallax images or (ii) a near view object in a region on the second-edge side is not the same between the first and second parallax images, an influence of the object being not the same is more noticeable (i.e., stereoscopic effect is more reduced) as compared to a distant-view side. In view of this, in order to prevent stereoscopic effect from being reduced by near view objects that are not the same, it is preferable that the matching pixel value determining means determine in particular whether or not a pixel value of a pixel in a region on the first-edge side of the first parallax image (or a region on the second-edge side of the second parallax image) matches a pixel value of a corresponding pixel of the second parallax image (or the first parallax image) at a corresponding position. That is, in this case, it is preferable that the target pixel be a pixel (i.e., a pixel closer to the first edge) in a region on the first-edge side of the first parallax image or a pixel (i.e., a pixel closer to the second edge) in a region on the second-edge side of the second parallax image.

The image processing device in accordance with the present invention is preferably configured such that the width from the first edge of the first image region and the width from the second edge of the second image region, which image regions are specified by the image region specifying means, are set beforehand.

According to the configuration, the width from the first edge of the first image region and the width from the second edge of the second image region are set beforehand. Therefore, it is not necessary to determine the width (i.e., specify the first image region or the second image region) for each image. This makes it possible to simplify the process carried out by the image region specifying means, and thus to improve a processing speed of the entire device.

In a case where (i) the image processing device of the present invention carries out processing with respect to content consisting of two or more images and (ii) the content is distributed in real time, it is necessary to carry out image processing (processes carried out by the image region specifying means and the pixel value changing means) along with such content distribution. In this case, if a delay occurs in the image processing, then an image displayed three-dimensionally may have a flicker.

In this regard, since the width is set beforehand, it is possible to prevent such a delay from occurring in the image processing. Therefore, the configuration is particularly suitable for a case where the image processing is carried out with respect to the content distributed in real time.

The image processing device in accordance with the present invention is preferably configured such that the predetermined pattern is a pattern of a single dark color. The configuration makes it possible to surely suppress a reduction in a stereoscopic effect.

An image processing device in accordance with the present invention preferably further includes: luminance value changing means for generating a luminance change instruction for at least increasing, in an image region other than the first image region and the second image region specified by the image region specifying means, a luminance value of a pixel of an object that exists in one of the first and second parallax images and does not exist in the other.

According to the configuration, in a case where an object in an image region whose pixel value is not changed by the pixel value changing means to the pixel value indicative of the predetermined pattern exists in one of the first and second parallax images and does not exist in the other, the object does not overlap any object even when the first and second parallax images are displayed three-dimensionally. On the other hand, in a case where an object exists in both of the first and second parallax images, objects in the respective images overlap each other when the first and second parallax images are displayed, three-dimensionally. That is, when the first and second parallax images are displayed three-dimensionally, the object that exists in one of the first and second parallax images and does not exist in the other has a luminance value up to about half as large as (about one to two times as small as) a luminance value of the object that exists in both of the first and second parallax images.

In view of this, the luminance value changing means generates the luminance change instruction for at least increasing a luminance value of the object that exists in one of the first and second parallax images and does not exist in the other. This makes it possible to increase the luminance value of such an object in a device (e.g., display device) for achieving a three-dimensional display. Accordingly, it is possible to suppress luminance unevenness when images are displayed three-dimensionally, and thus possible to provide an image (natural image) giving no feeling of strangeness to a viewer.

The image processing device in accordance with the present invention is preferably configured such that the first image region and the second image region each have a quadrangular shape.

According to the configuration, the following occurs. That is, in a case where each of the first and second image regions has a quadrangular shape, each of the first and second parallax images having the respective first and second image regions also has a quadrangular shape. Therefore, a display screen of the display device in which these images are displayed three-dimensionally should also have a quadrangular shape to achieve good display efficiency. In this case, such a display screen can be produced by obtaining its quadrangular substrate (panel) from a glass plate.

On the other hand, in a case where each of the first and the second image regions has a shape (complicated shape) other than a quadrangular shape, the display screen is to have also a complicated shape instead of quadrangular shape in view of display efficiency. Accordingly, the substrate of the display screen having a complicated shape is to be obtained from a glass plate. That is, the substrate may not be obtained from the glass plate with good efficiency depending on its shape.

That is, in a case where each of the first and second image regions has a quadrangular shape, the substrate of the display screen for three-dimensional display is usually arranged to have a quadrangular shape in view of display efficiency. This makes it possible to obtain the substrate from the glass plate with good efficiency as compared to a case where each of the first and second image regions has a complicated shape instead of the quadrangular shape (i.e., the substrate of the display screen has a complicated shape). For this reason, arranging the first and image regions to have a quadrangular shape makes it possible to increase mass productivity of not only the substrate of the display screen but also the display screen and the display device.

Further, the above configuration makes it possible to form, in a line, circuits for lighting pixels. Therefore, in a case where the image processing device of the present invention has such circuits, it is possible to simplify the design of the circuits.

A display device in accordance with the present invention preferably includes: the foregoing image processing device; and a display for displaying an image whose pixel value is changed by the image processing device.

According to the configuration, the display device includes the image processing device of the present invention. This makes it possible, in the similar manner to the image processing device, to prevent an unnatural region having no image (see (c) of FIG. 10) from appearing during three-dimensional display and thus possible to suppress a reduction in a stereoscopic effect.

A reproducing device in accordance with the present invention preferably includes: the foregoing image processing device; and reproduction control means for reproducing (i) an image whose pixel value is changed by the image processing device, which image is recorded in an information recording medium and/or (ii) an image whose pixel value is not changed by the image processing device, which image is recorded in the information recording medium or in another information recording medium.

According to the configuration, the reproducing device includes the image processing device of the present invention. This makes it possible (even if the display device does not include the image processing device), in the similar manner to the image processing device, to prevent an unnatural region having no image (see (c) of FIG. 10) from appearing during three-dimensional display and thus possible to suppress a reduction in a stereoscopic effect.

Further, in a case where the image whose pixel value is changed by the image processing device of the present invention is recorded in an information recording medium, it is possible to provide, to a viewer, a three-dimensional image in which the foregoing unnatural region does not appear merely by reproducing the image by the reproducing means.

Even in a case where the image (i.e., generally known conventional image for a three-dimensional display) whose pixel value is not changed by the image processing device of the present invention is recorded in an information recording medium, it is possible, like above, to provide to the viewer a three-dimensional image having no unnatural region in such a way that the reproducing means reproduces the image and the image processing device of the present invention orderly carries out processes of the image processing with respect to the image (e.g., image processing is carried out in real time during reproduction).

A recording device in accordance with the present invention preferably includes: the foregoing image processing device; recording control means for recording, to an information recording medium, an image whose pixel value is changed by the image processing device.

According to the configuration, the recording device includes the image processing device of the present invention. This makes it possible (even if the display device does not include the image processing device), in the same manner as in the image processing device, to prevent an unnatural region having no image (see (c) of FIG. 10) from appearing during three-dimensional display and thus possible to suppress a reduction in a stereoscopic effect.

Further, it is possible to record, to the information recording medium, the image whose pixel value is changed by the image processing device. Therefore, even if the display device and/or the reproducing device do/does not include the image processing device, it is possible to provide to the viewer the three-dimensional image in which the foregoing unnatural region does not appear by merely reading out the image.

An information recording medium in accordance with the present invention preferably includes an image recording area in which (i) an image whose pixel value is changed by the foregoing image processing device and/or (ii) an image whose pixel value is not changed by the image processing device are/is recorded.

According to the configuration, it is possible to record the image whose pixel value is changed by the image processing device of the present invention. This makes it possible to reproduce the image in a case where the information recording medium of the present invention is subjected to reproduction control. Accordingly, it is possible to provide to the viewer an image in which a reduction in a stereoscopic effect is suppressed.

Further, the image recording area is capable of recording thereto also the image whose pixel value is not changed by the image processing device. This enables the image processing device (or the reproducing device or the display device which has the function of the image processing device) to carry out image processing with respect to the image by causing for example the reproducing device to read out the image. Therefore, even in this case, it is possible to provide, to the viewer, an image in which a reduction, in a stereoscopic effect is suppressed.

Further, for example the reproducing device is to reproduce the image recorded in the information recording medium, which image has a pixel value changed in advance. Accordingly, it is not necessary to change a pixel value every time the image is reproduced.

Further, (i) an image processing device control program for causing the foregoing image processing device to, operate, the image processing device control program causing a computer to function as the means recited in the image processing device, and (ii) a computer-readable storage medium in which the image processing device control program is stored are also encompassed in the technical scope of the present invention.

According to the control program, it is possible to realize the image processing device on the computer by causing the computer to function as the foregoing means. Further, according to the storage medium, it is possible to execute the control program read out from the storage medium on a general purpose computer.

An information recording medium in accordance with the present invention preferably includes: a recordable area having an image recording area to which (i) an image whose pixel value is changed by the foregoing image processing device and/or (ii) an image whose pixel value is not changed by the image processing device are/is recorded; and a reproduction-only area in which the foregoing image processing device control program is recorded.

According to the configuration, the information recording medium of the present invention has the reproduction-only area and the recordable area having the image recording area. This makes it possible to collectively store (to one (1) information recording medium) the image processing device control program and an image (image that is not processed) to be processed by the control program, i.e., the image whose pixel value is not changed. Accordingly, even in a case of a reproducing device (e.g., PC) not having the control program, it is possible to carry out image processing of the image processing device of the present invention with respect to the image by reading out the control program and the image that is not processed from the information recording medium of the present invention when the information recording medium is inserted. As such, it is possible, by using the information recording medium of the present invention, to prevent a reduction in a stereoscopic effect during three-dimensional display.

Further, according to the configuration, since the information recording medium of the present invention has the reproduction-only area and the recordable area having the image recording area, it is possible to collectively store (to one (1) information recording medium) the image processing device control program and the image (i.e., processed image) whose pixel value is changed by the image processing device (or the control program thereof).

For example, in a case where (i) the information recording medium recording the control program therein does not have the recordable area having the image recording area and (ii) the reproducing device does not have the control program, a user (viewer) needs to (a) take out the information recording medium after the control program is read out from the information recording medium and (b) insert another information recording medium having the recordable area to which a processed image can be recorded so as to record the processed image to the another information recording medium.

The information recording medium of the present invention is capable of collectively storing therein the control program and the processed image. Therefore, even if the information recording medium is inserted into reproducing device having no control program, the user does not need to change information recording media like above because the control program recorded in the information recording medium is usable and the processed image can be recorded to the information recording medium. This makes it possible to reduce the burden on the user and improve convenience of the information recording medium.

Alternatively, the present invention can be described as below.

That is, a method for displaying a three-dimensional image in accordance with the present invention is a method of causing a display device to display an image for a right eye and an image for a left eye and giving a parallax in a horizontal direction to the image for the right eye and the image for the left eye so that a user perceives the images as a three-dimensional image, wherein at least a first region having a predetermined first width from a right edge of the image for the right eye or a second region having a predetermined second width from a left edge of the image for the left eye is not correlated with a corresponding region in the image for the left eye or a corresponding region in the image for the right eye.

Further, the method for displaying the three-dimensional image in accordance with the present invention is preferably arranged such that the predetermined first width and the predetermined second width are fixed throughout a series of image content.

Further, the method for displaying the three-dimensional image in accordance with the present invention is preferably arranged such that the predetermined first width is a distance between (i) a pixel that exists in a left half of the image for the left eye and is positioned rightmost in image information included only in the image for the left eye and (ii) the left edge of the image for the left eye, and the predetermined second width is a distance between (a) a pixel that exists in a right half of the image for the right eye and is positioned leftmost in image information included only in the image for the right eye and (b) the right edge of the image for the right eye.

Further, the method for displaying the three-dimensional image in accordance with the present invention is preferably arranged such that a boundary of a region to be removed, which boundary extends from top to bottom of the image, is a straight line.

Further, the method for displaying the three-dimensional image in accordance with the present invention is preferably a method for displaying the foregoing three-dimensional image, wherein the three-dimensional image is displayed such that, after removal of the foregoing region, luminance of image information existing only in either one of the images for the left eye and the right eye in the vicinity of the right edge of the image for the left eye or the left edge of the image for the right eye is increased.

### [Supplemental Remarks]

Finally, the blocks of the image processing device 1, particularly the image obtaining section 12, the parallax maximum width detection section 13 (target pixel selection section 131, matching pixel value determining section 132, distance calculation section 133 and distance comparison section 134), the image region specifying section 14, the pixel value changing section 15, the luminance value changing section 16 and the image output section 17 may be constituted by hardware logic or realized by software by means of a CPU as shown below.

That is, the image processing device 1 includes a CPU (central processing unit) that executes the order of a control program for realizing the aforesaid functions, ROM (read only memory) that stores the control program, RAM (random access memory) that develops the control program, and a storage device (storage medium), such as memory, that stores the control program and various types of data therein. The object of the present invention is realized by a predetermined storage medium. The storage medium stores, in computer-readable manner, program codes (executable program, intermediate code program, and source program) of the control program of the image processing device 1, which is software for realizing the aforesaid functions. The storage medium is provided to the image processing device 1. With this arrangement, the image processing device 1 (alternatively, CPU or MPU) as a computer reads out and executes program code stored in the storage medium provided.

The storage medium may be tape based, such as a magnetic tape or cassette tape; disc based, such as a magnetic disk including a Floppy® disk, and hard disk and optical disc including CD-ROM, MO, MD, DVD, and CD-R; card based, such as an IC card (including a memory card) and an optical card; or a semiconductor memory, such as a mask ROM, EPROM, EEPROM, and a flash ROM.

Further, the image processing device 1 may be arranged so as to be connectable to a communications network so that the program code is supplied to the image processing device 1 through the communications network. The communications network is not to be particularly limited. Examples of the communications network include the Internet, intranet, extranet, LAN, ISDN, VAN, CATV communications network, virtual private network, telephone network, mobile communications network, and satellite communications network. Further, a transmission medium that constitutes the communications network is not particularly limited. Examples of the transmission medium include (i) wired lines such as IEEE 1394, USB, power-line carrier, cable TV lines, telephone lines, and ADSL lines and (ii) wireless connections such as IrDA and remote control using infrared light, Bluetooth®, 802.11 wireless, HDR, mobile phone network, satellite connections, and terrestrial digital network. Note that the present invention can be also realized by the program codes in the form of a computer data signal embedded in a carrier wave which is embodied by electronic transmission.

The invention is not limited to the description of the embodiments above, but may be altered within the scope of the claims. An embodiment based on a proper combination of technical means altered within the scope of the claims is encompassed in the technical scope of the invention.

### INDUSTRIAL APPLICABILITY

The present invention makes it possible to suppress a reduction in a stereoscopic effect in a three-dimensional display utilizing a parallax. Therefore, the present invention is applicable to any of the following methods: a side-by-side method, a frame sequential method, a parallax barrier method, a lenticular method, and a lens array method. In a case where a three-dimensional display is to be viewed through glasses, a method of the glasses to which the present invention is applicable is any of the following methods: an active shutter method, a color filter method, a linear polarization method, and a circular polarization method.

### REFERENCE SIGNS LIST

1 Image processing device
10 Recording/reproducing device (Reproducing device, Recording device)
14 Image region specifying section (Image region specifying means)
15 Pixel value changing section (Pixel value changing means)
16 Luminance value changing section (Luminance value changing means)
40 Display device
100 Optical disc (information recording medium)
132 Matching pixel value determining section (Matching pixel value determining means)
134 Distance comparison section (Maximum distance specifying means)
181 Black display width information (Maximum distance)
351 Reproduction control section (Reproduction control means)
352 Recording control section (Recording control means)
1021 Image recording area
I1 Left side (First edge)
I2 Right side (Second edge)
I3 Upper side (Third edge)
I4 Lower side (Fourth edge)
T1 First image region
T2 Second image region
102 RE layer (Recordable area)
104 ROM layer (Reproduction-only area)

1. An image processing device, for carrying out image processing with respect to a first parallax image and a second parallax image which are for a three-dimensional display, the first parallax image and the second parallax image each having (i) a first edge and a second edge opposed to each other in a first axis direction and (ii) a third edge and a fourth edge opposed to each other in a second axis direction orthogonal to the first axis direction,
said image processing device, comprising:
image region specifying means for specifying a first image region and/or a second image region; and
pixel value changing means for changing a pixel value of the first image region and/or the second image region specified by the image region specifying means to a pixel value indicative of a predetermined pattern,
the first image region (i) including an object that exists in the first parallax image and does not exist in the second parallax image and (ii) being defined based on the first edge of the first parallax image and extending continuously from the third edge to the fourth edge, and
the second image region (a) including an object that exists in the second parallax image and does not exist in the first parallax image and (b) being defined based on the second edge of the second parallax image and extending continuously from the third edge to the fourth edge.

2. An image processing device according to claim 1, further comprising:
matching pixel value determining means for determining (i) whether or not a pixel value of a target pixel of the first parallax image matches a pixel value of a corresponding pixel of the second parallax image at a position corresponding to the target pixel of the first parallax image and (ii) whether or not a pixel value of a target pixel of the second parallax image matches a pixel value of a corresponding pixel of the first parallax image at a position corresponding to the target pixel of the second parallax image; and
maximum distance specifying means for specifying a maximum, distance between (a) a position of the target pixel whose pixel value is determined by the matching pixel value determining means to match the pixel value of the corresponding pixel and (b) the first edge of the first parallax image or the second edge of the second parallax image,
the image region specifying means determining that a width from the first edge of the first image region and a width from the second edge of the second image region are each the maximum distance specified by the maximum distance specifying means.

3. The image processing device according to claim 1, wherein the width from the first edge of the first image region and the width from the second edge of the second image region, which image regions are specified by the image region specifying means, are set beforehand.

4. The image processing device according to claim 1, wherein the predetermined pattern is a pattern of a single dark color.

5. An image processing device according to claim 1, further comprising:
luminance value changing means for generating a luminance change instruction for at least increasing, in an image region other than the first image region and the second image region specified by the image region specifying means, a luminance value of a pixel of an object that exists in one of the first and second parallax images and does not exist in the other.

6. The image processing device according to claim 1, wherein the first image region and the second image region each have a quadrangular shape.

7. A display device, comprising:
an image processing device recited in claim 1; and
a display for displaying an image whose pixel value is changed by the image processing device.

8. A reproducing device, comprising:
an image processing device recited in claim 1; and
reproduction control means for reproducing (i) an image whose pixel value is changed by the image processing device, which image is recorded in an information recording medium and/or (ii) an image whose pixel value is not changed by the image processing device, which image is recorded in the information recording medium or in another information recording medium.

9. A recording device, comprising:
an image processing device recited in claim 1; and
recording control means for recording, to an information recording medium, an image whose pixel value is changed by the image processing device.

10. A method for controlling an image processing device, the image processing device carrying out image processing with respect to a first parallax image and a second parallax image which are for a three-dimensional display, the first parallax image and the second parallax image each having (i) a first edge and a second edge opposed to each other in a first axis direction and (ii) a third edge and a fourth edge opposed to each other in a second axis direction orthogonal to the first axis direction,
said method, comprising the steps of:
specifying a first image region and/or a second image region; and
changing a pixel value of the first image region and/or the second image region specified in the step of specifying to a pixel value indicative of a predetermined pattern,
the first image region (i) including an object that exists in the first parallax image and does not exist in the second parallax image and (ii) being defined based on the first edge of the first parallax image and extending continuously from the third edge to the fourth edge, and
the second image region (a) including an object that exists in the second parallax image and does not exist in the first parallax image and (b) being defined based on the second edge of the second parallax image and extending continuously from the third edge to the fourth edge.

11. An information recording medium, comprising an image recording area in which (i) an image whose pixel value is changed by an image processing device recited in claim 1 and/or (ii) an image whose pixel value is not changed by the image processing device are/is recorded.

12. An image processing device control program for causing an image processing device recited in claim 1 to operate, said image processing device control program causing a computer to function as the means recited in the image processing device.

13. A computer-readable storage medium in which an image processing device control program recited in claim 12 is stored.

14. An information recording medium, comprising:
a recordable area having an image recording area to which (i) an image whose pixel value is changed by an image processing device recited in claim 1 and/or (ii) an image whose pixel value is not changed by the image processing device are/is recorded; and
a reproduction-only area in which an image processing device control program recited in claim 12 is recorded.
